(19) United States
(12) Patent Application Publication
(10) Pub. No.: US 2011/0246188 A1
(43) Pub. Date: Oct. 6, 2011

(54) NONVOLATILE STORAGE SYSTEM AND MUSIC SOUND GENERATION SYSTEM

(76) Inventor: Masahiro Nakanishi, Kyoto, (JP)

(21) Appl. No.: 13/124,704

(22) PCT Filed: May 26, 2010
(86) PCT No.: PCT/JP2010/003532

§ 371 Date: Apr. 18, 2011

(30) Foreign Application Priority Data
May 27, 2009 (JP) 2009-127344

(51) Int. Cl. G10L 11/04; G06F 12/00

(52) U.S. Cl. 704/207; 711/154; 711/E12.001; 704/E11.006

(57) ABSTRACT

A music sound generation system is formed with a high sound quality and with a small size using a large-capacity NAND flash memory for storing music sound data. Music sound data is divided into N pitch groups and stored into N different storage modules as being divided in these storage modules. A sound generation command classification unit (3000) classifies sound generation commands provided from an external unit into N sound generation command groups. A read command unit in each access module reads data from a storage module based on the sound generation command group. This structure enables music sound data to be read from a plurality of storage modules in parallel. When used in a system that cannot predict the pitch of music sound data for which a read command is transmitted, such as a music sound generation system, this structure enables a plurality of pieces of data to be read from a plurality of storage modules in parallel, and shortens the sound generation delay time to fall within its a permissible range.

### TECHNICAL FIELD

The present invention relates to a music sound generation system and a nonvolatile storage system that generate music sound by reading music sound data from a plurality of nonvolatile storage modules prestoring music sound data such as instrumental sound, and subjecting the music sound data to signal processing.

### BACKGROUND ART

Nonvolatile storage modules that use rewritable nonvolatile memories have attracted widespread popularity in the form of removable storage devices used mainly in semiconductor memory cards. Although semiconductor memory cards are much more expensive than optical discs and tape media, they are compact, lightweight, earthquake-resistant, and can be handled easily. With these advantages, semiconductor memory cards have increased popularity as recording media for portable devices, such as digital still cameras and portable telephones.

Such a semiconductor memory card includes a flash memory functioning as a main memory that is nonvolatile and a memory controller for controlling the flash memory. The memory controller controls reading and writing to and from the flash memory in response to a read command and a write command transmitted from an access module, such as a digital still camera. Nonvolatile storage modules may also be formed as non-removable storage devices, and may be built in digital still cameras or portable audio devices, or may be built in personal computers in place of hard disks.

The flash memory includes a memory cell array and an I/O register (RAM) for temporarily storing data read from the memory cell array or for temporarily storing data written from an external unit. The flash memory requires a relatively long time to write or erase data in a memory cell included in its memory cell array. To shorten the time required for writing or erasing, the flash memory is formed in a manner that data stored in a plurality of memory cells can be erased at a time or data can be written into a plurality of memory cells at a time. More specifically, the flash memory consists of a plurality of physical blocks, each of which includes a plurality of pages. Data is erased from the flash memory in units of physical blocks, whereas data is written to the flash memory in units of pages.

A music sound generation system, which generates sound of a music instrument (hereafter referred to as “music sound”) in accordance with, for example, an operation for striking a key (key stroke operation), may store music sound data for an electronic music instrument in a ROM. The music sound generation system normally has 32 or more sound generation channels, and generates music sound by assigning a sound generation channel to each key in the order in which each key is struck. This type of system is required to generate music sound in response to a random key stroke operation, and thus uses, as a ROM for storing music sound data, a mask ROM from which data can be randomly read at a high speed.

According to the disclosure of Patent Literature 1, the unit price of a flash memory per bit is expected to become lower than the unit price of a mask ROM per bit as the flash memory technology advances. Patent Literature 1 describes a technique for lowering the system cost through streamlining by using, as a ROM for storing music sound data, a flash memory whose random reading speed is slower than a mask ROM.

To satisfy the demand for larger capacity and lower cost, the flash memories have employed multivaluing and also undergone process shrink. Gigabit-class multivalued NAND flash memories (hereafter referred to as “large-capacity flash memories”) have then become major flash memories. As a result, the unit price of a flash memory per bit has become much lower than the unit price of a mask ROM per bit. Also, the capacity of a flash memory per unit area has become much larger than the capacity of a mask ROM per unit area. This increases the possibility for lowering the system cost further as well as for downsizing the system further.

In an embodiment shown in Patent Literature 1, a binary NAND flash memory (Product number: TC58V64FT) is used. This binary flash NAND flash memory is an old-type binary NAND flash memory having a small capacity and a high speed. More specifically, this memory has a capacity of 64 megabits and a read time (hereafter, TR) of 7 microseconds. The read time TR is the time taken to read data from a memory cell array by accessing an I/O register.

### CITATION LIST

### Patent Literature

Patent Literature 1: Japanese Unexamined Patent Publication No. 2000-284783

### SUMMARY

### Technical Problem

To maintain its high sound quality, a music sound generation system may store uncompressed music sound data, which is digitally recorded sound data of an instrument such as a piano, into a mask ROM or into a NAND flash memory. Such a music sound generation system will now be described. The system is required to include memory with a capacity of, for example, about 621 megabytes as given by expression (1).

44.1 [kHz]*40 [second]*2 [byte]*2 [touch]*88 [key]≈621 [megabyte] Expression (1)

In expression (1), 44.1 [kHz] is the sampling frequency, 40 [second] is the period for which sound is being generated for a single key, 2 [byte] is the word length of a single sample of music sound data, and 2 [touch] indicates that two different cases are involved: one in which the key is struck with the strongest touch and the other in which the key is struck with the weakest touch, and 88 [key] is the total number of keys included in the piano.

When using the above binary NAND flash memory having a capacity of 64 megabits, the system would be required to include about 77 such NAND flash memories as given by expression (2).

621 [megabyte]/64 [megabit]≈77 Expression (2)

In this case, the music sound generation system cannot be downsized.

When using a gigabit-class large-capacity flash memory, which is currently a major flash memory, the system would be required to include only a single to several such large-capacity flash memories. The system can store uncompressed music sound data of 621 megabytes using the single to several large-capacity flash memories.

However, the page size of the large-capacity flash memory has been increased and the large-capacity flash memory has been multivalued to increase the speed at which a large volume of data is written or read at a time. This has significantly increased the read time TR of the flash memory to as long as 50 μs. The music sound generation system is normally required to generate music sound using 32 channels simultaneously. By the time when the music sound generation system generates music sound using the 32th channel, the delay time taken before sound is generated (sound generation delay time) would be at least 1.6 millisecond as written in expression (3).

Sound generation delay time=50 microseconds*32=1.6 millisecond Expression (3)

The sound generation delay time is the time taken from when a key stroke operation is performed to when the sound generation is started. The permissible range of the sound generation delay time is typically a range of 1 millisecond. The sound generation delay time exceeding 1 millisecond will create a feeling of strangeness in the musical performance, which is unacceptable for any music sound generation system.

It is an object of the present invention to provide an access module, a storage module, a music sound generation system, and a data writing module each of which is used to form a music sound generation system that has a high sound quality and has a small size using, as a memory for storing music sound data, a large-capacity flash memory or the like, which is currently a major flash memory.

### Solution to Problem

To solve the above problem, the nonvolatile storage system of the present invention is a nonvolatile storage system including a nonvolatile storage module and an access module that reads data stored in the nonvolatile storage module.

The nonvolatile storage module includes N storage modules consisting of a first storage module to an N-th storage module (N is a natural number). Data that is stored into the nonvolatile storage module is stored into at least one storage module selected from the first to N-th storage modules.

The access module includes a data classification unit and a read command unit.

The data classification unit determines a storage module storing the data among the N storage modules consisting of the first storage module to the N-th storage module in accordance with a data read command provided from an external unit. The read command unit reads data from one of the first to N-th storage modules based on the determination performed by the data classification unit.

This nonvolatile storage system enables data to be read from a plurality of (N) storage modules in parallel. This structure enables a music sound generation system to be formed with a high sound quality as well as with a small size using, for example, a large-capacity flash memory, which is currently a major flash memory, as a memory for storing music sound data.

To solve the above problem, the music sound generation system of the present invention includes a storage module group and an access module. The storage module group includes N storage modules consisting of a first storage module to an N-th storage module (N is a natural number), and divides music sound data into N pitch groups consisting of a first pitch group to an N-th pitch group (N is a natural number), and stores the music sound data as being divided in the pitch groups in a manner that music sound data belonging to a k-th pitch group is stored into a k-th storage module (k is a natural number satisfying 1≦k≦N). The access module transmits a read command for reading data to the storage module group.

The access module includes a sound generation command classification unit and N read command units.

The sound generation command classification unit classifies a sound generation command provided from an external unit into N sound generation groups consisting of a first sound generation command group to an N-th sound generation command group (N is a natural number), and determines a pitch group to which the sound generation command belongs among the N pitch groups. When determining that the sound generation command belongs to a k-th pitch group (k is a natural number satisfying 1≦k≦N), the sound generation command classification unit classifies the sound generation command into a k-th sound generation command group (k is a natural number satisfying 1≦k≦N).

The N read command units output a data read command to the N storage modules each of which stores music sound data corresponding to a different one of the N sound generation command groups.

In this music sound generation system, music sound data is classified into different pitch groups, and the music sound data is stored as being divided in the N storage modules in correspondence with the classification of the music sound data. The access module then can read music sound data from the plurality of (N) storage modules in parallel in accordance with a read command. This structure enables a music sound generation system to be formed with a high sound quality as well as with a small size using a large-capacity flash memory, which is currently a major flash memory, as a memory for storing music sound data.

It is preferable that each of the storage modules includes a plurality of nonvolatile storage modules, and the plurality of nonvolatile storage modules store music sound data in a multiplex manner.

It is preferable that each of the N read command units reads data from a first nonvolatile storage module among the nonvolatile storage modules in accordance with a single sound generation command provided from an external unit, and when receiving another sound generation command before completely reading the data from the first nonvolatile storage module, each of the N read command units reads data in parallel from a second nonvolatile storage module different from the first nonvolatile storage module from which the data is being read among the nonvolatile storage modules.

It is preferable that each of the N read command units reads a plurality of samples of music sound data in response to a single read command.

### Advantageous Effects

According to the present invention, music sound data is divided into N pitch groups (pitch groups 1 to N), and the N pitch groups of music sound data are stored into N different storage modules (storage modules 1 to N). A sound generation command classification unit classifies sound generation commands provided from an external unit as N sound generation commands (or into sound generation command groups 1 to N) by determining, for each sound generation command, one of the N pitch groups to which each sound generation command belongs. Based on the sound generation command groups 1 to N, N read command units read music sound data from the storage modules 1 to N. This structure enables music sound data to be read from a plurality of storage modules in parallel. The present invention is applicable to a system that cannot predict the pitch of music sound data for which a read command is transmitted, such as a music sound generation system. The application of the present invention to such a system enables a plurality of pieces of data to be read from a plurality of storage modules in parallel, and shortens the sound generation delay time to fall within its permissible range of 1 millisecond. The present invention therefore enables the music sound generation system to be formed at a low cost as well as with a small size using, as a memory for storing music sound data, a large-capacity flash memory, which is currently a major flash memory.

### BRIEF DESCRIPTION OF DRAWINGS

FIG. 1A is a block diagram of a nonvolatile storage module used in a music sound generation system according to a first embodiment of the present invention.

FIG. 1B is a block diagram of an access module used in the music sound generation system according to the first embodiment of the present invention.

FIG. 2 schematically shows the structure of memory cell arrays included in nonvolatile memory banks 112 to 142.

FIG. 3 shows the recording format of data in a page using page P0 included in PB0 in this example.

FIG. 4 shows a bit format for a physical sector number PSN.

FIG. 5 is a block diagram of a music sound data buffer 231.

FIG. 6A schematically shows a channel assign table 232.

FIG. 6B schematically shows the channel assign table 232.

FIG. 6C schematically shows the channel assign table 232.

FIG. 7 schematically shows an NN table 233A.

FIG. 8 shows a memory map of a channel register 241.

FIG. 9 shows a memory map of an MM register 242.

FIG. 10 shows a bit format of a single sample of music sound data.

FIG. 11 schematically shows property information for music sound data of a piano.

FIG. 12 schematically shows memory structure information.

FIG. 13A is a flowchart showing a main routine of a CPU 230A.

FIG. 13B is a flowchart showing an interrupt routine of the CPU 230A.

FIG. 14A is a flowchart showing a main routine of a read command unit 240.

FIG. 14B is a flowchart showing an interrupt routine 1 of the read command unit 240.

FIG. 14C is a flowchart showing an interrupt routine 2 of the read command unit 240.

FIG. 15 shows a bit format of read-command information.

FIG. 16 shows a bit format of play data.

FIG. 17 is a flowchart showing the processing performed by a memory controller.

FIG. 18 is a timing chart for a read command that is transmitted from a memory controller to a nonvolatile memory bank.

FIG. 19 shows a bit format of music sound data that is read from a storage module 100A onto an external bus.

FIG. 20 is a flowchart showing the processing performed by a signal processing unit 220.

FIG. 21 is a graph showing temporal changes in data LD after a key is struck when a flag PD is at 0.

FIG. 22 is a graph showing temporal changes in the data LD after a key is struck when the flag PD is at 1.

FIG. 23 shows time slots for the signal processing performed per sampling cycle.

FIG. 24A is a timing chart for the music sound generation system.

FIG. 24B is a timing chart for the music sound generation system.

FIG. 24C is a timing chart for the music sound generation system.

FIG. 25 is a block diagram of a music sound generation system according to a second embodiment of the present invention.

FIG. 26 is a table showing the correspondence between the pitch code of music sound data and music sound data that is stored as being divided in storage modules 1100 to 1300.

FIG. 27 shows a memory map representing the recording state of the storage module 1100.

### REFERENCE SIGNS LIST

100A, 1100, 1200, 1300 storage module
110A, 120A, 130A, 140A nonvolatile storage module
111A, 121A, 131A, 141A memory controller
112, 122, 132, 142 nonvolatile memory bank
113, 123, 133, 143 I/O register
114, 124, 134, 144 memory cell array
200A, 2000, 2100, 2200, 2300 access module
210, 410, 510 input/output unit
220 signal processing unit
230, 420, 520 CPU
231 music sound data buffer
231_0 to 231_3 buffer
231_0a, 231_0b, 231_1a, 231_1b dual port RAM
231_2a, 231_2b, 231_3a, 231_3b dual port RAM
231_0c, 231_1c, 231_2c, 231_3c multiplexer
231_0d, 231_1d, 231_2d, 231_3d demultiplexer
232 channel assign table
233A NN table
234 play data buffer
235 transfer monitoring unit
236 file system unit
237 multiplexing unit
240 read command unit
250, 430, 530 write command unit
300 master keyboard
310 internet
400, 500 data writing module
1000 storage module group
3000 sound generation command classification unit

### DESCRIPTION OF EMBODIMENTS

The best mode for carrying out the invention will now be described. The above structure described as the solution to the problem corresponds to a second embodiment of the present invention. The operations performed by the components of the second embodiment will be described as a first embodiment of the present invention.

### First Embodiment

### 1.1 Structure of Music Sound Generation System

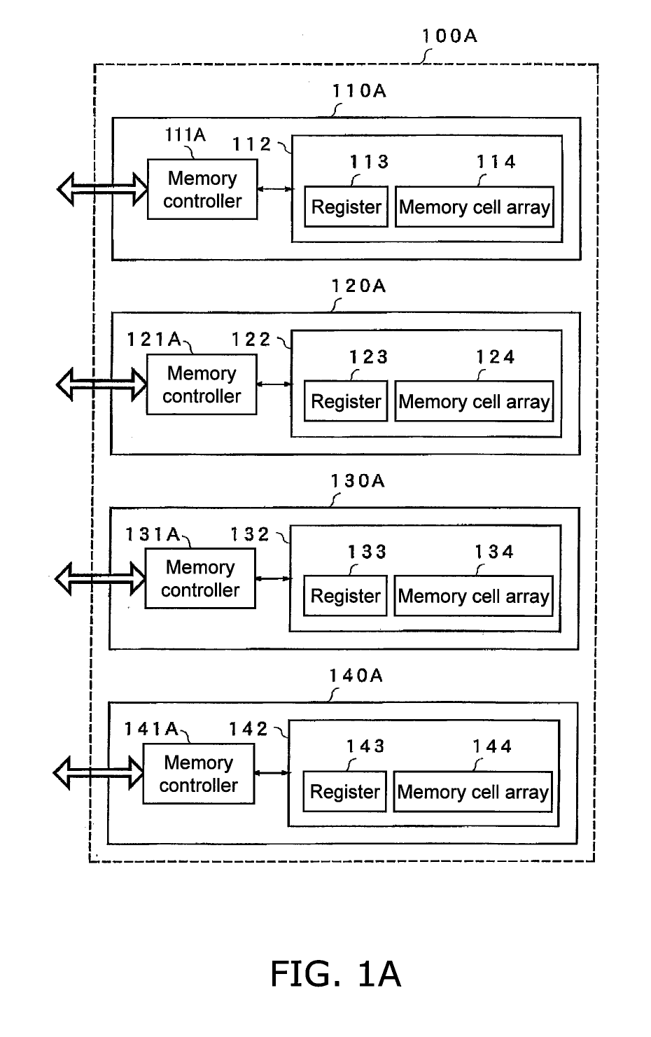

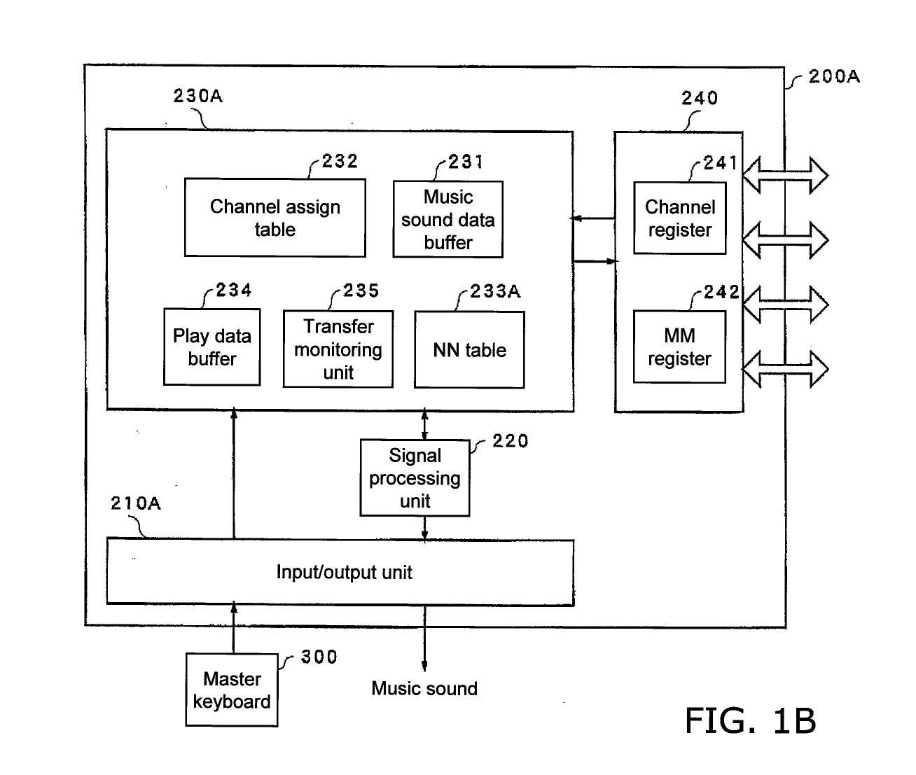

FIGS. 1A and 1B are block diagrams of a music sound generation system (nonvolatile storage system) according to the first embodiment. The music sound generation system includes a storage module 100A shown in FIG. 1A and an access module 200A shown in FIG. 1B.

As shown in FIG. 1A, the storage module 100A includes nonvolatile storage modules 110A, 120A, 130A, and 140A, which are arranged in a single package. The storage module 100A is mounted onto the access module when used.

The nonvolatile storage modules 110A 120A, 130A, and 140A respectively include memory controllers 111A, 121A, 131A, and 141A and nonvolatile memory banks 112, 122, 132, and 142.

As shown in FIG. 1B, the access module 200A includes an input/output unit 210A, a signal processing unit 220, a CPU 230A, and a read command unit 240. The access module 200A can output music sound obtained using 32 channels simultaneously. The 32 channels are given channel numbers CH0 to CH31.

The CPU 230A includes a music sound data buffer 231, a channel assign table 232, an NN table 233A, a play data buffer 234, and a transfer monitoring unit 235.

### 1.1.1 Nonvolatile Storage Modules 110A to 140A

The components of the nonvolatile storage modules 110A to 140A will now be described in detail.

The nonvolatile memory banks 112 to 142 are flash memories, and respectively include I/O registers 113, 123, 133, and 143 and memory cell arrays 114, 124, 134, and 144.

The I/O registers 113 to 143 are RAMs each having a capacity of 4096+128 bytes.

Each of the memory cell arrays 114 to 144 includes 1024 physical blocks. A physical block is the unit for erasing data from a flash memory. A physical block is hereafter referred to as “PB”, a physical block number as “PBN”, and a physical sector number as “PSN”. For example, a physical block whose PBN (physical block number) is 0 is referred to as PB0.

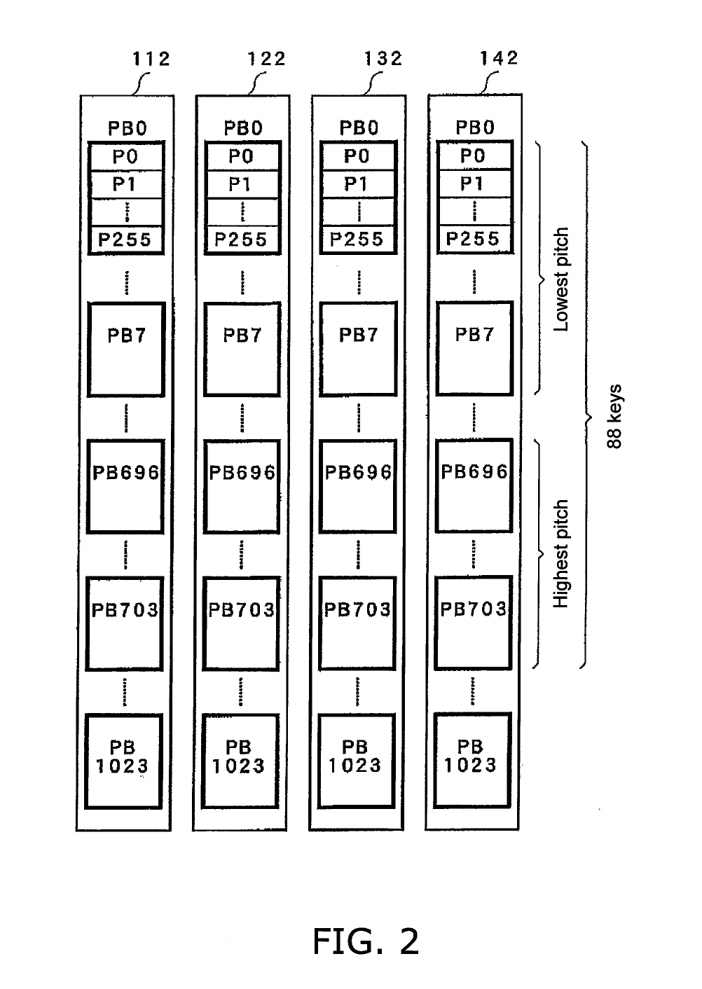

FIG. 2 schematically shows the structure of memory cell arrays included in the nonvolatile memory banks 112 to 142. Each of the nonvolatile memory banks 112 to 142 includes physical blocks PB0 to PB1023. Each physical block consists of 256 pages (P0 to P255).

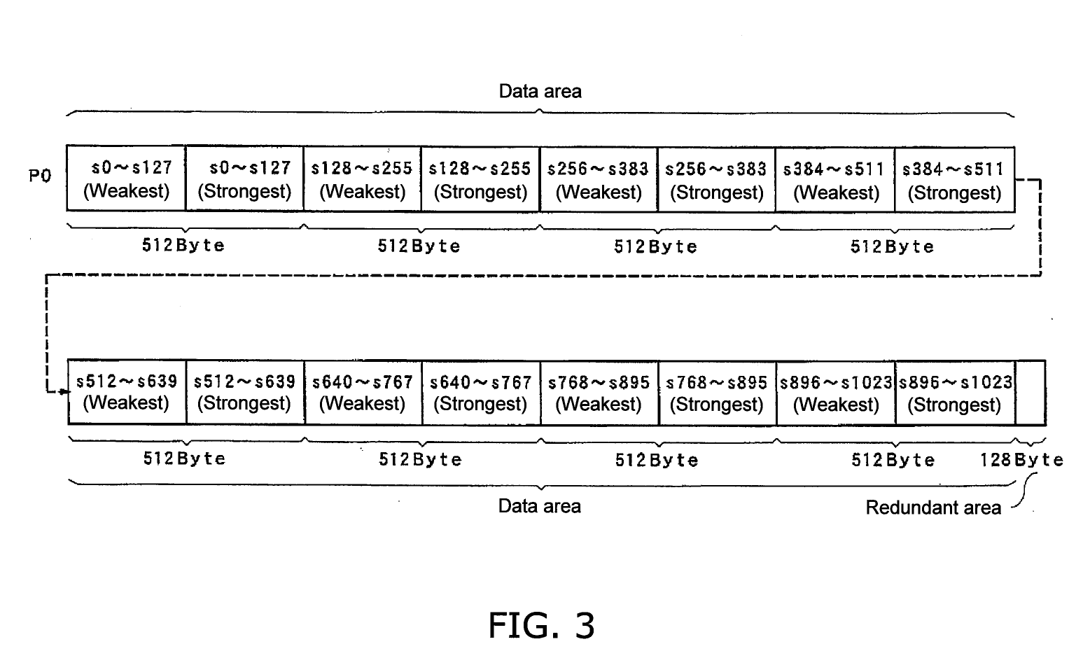

FIG. 3 shows the recording format of data in a page. The recording format of data in page P0 included in physical block PB0 is shown in this example. Each page included in a physical block consists of a data area having 4096 bytes and a redundant area having 128 bytes. In the present embodiment, the data area is divided in eight sectors, each of which has a capacity of 512 bytes. The redundant area is unused. Data recorded in the page will be described in detail later.

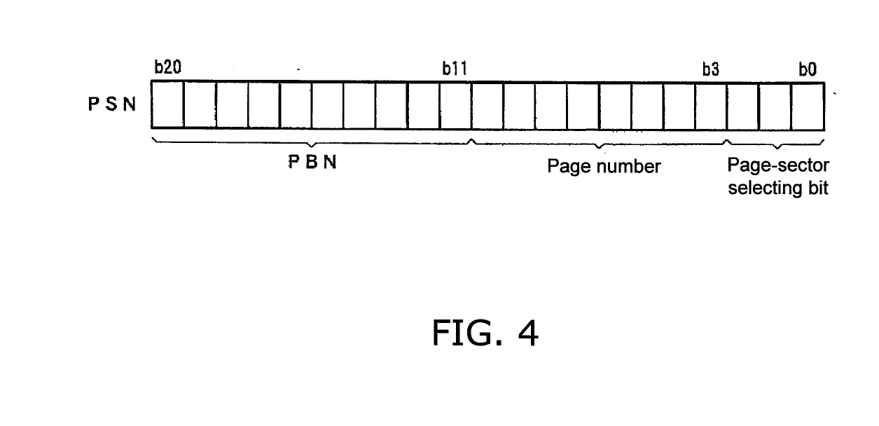

FIG. 4 shows a bit format for the physical sector number PSN. In FIG. 4, bits b0 to b2 each are a page-sector selecting bit, which is used to select a sector included in a page, bits b3 to b10 indicate a page number, and bits b11 to b20 indicate a physical block number.

The page-sector selecting bits correspond to the quotient of the page size (the start address of the page) and the sector size. In the present embodiment, the page size is 4096+128 bytes and the sector size is 512 bytes. In this case, one page is divided in eight sectors as shown in FIG. 3. These sectors are selected using the three lower-order bits of the physical address described above. The page size or the sector size should not be limited to these values. The page-sector selecting bits may be variable in accordance with the page size and the sector size.

The memory controllers 111A to 141A each may include an interface circuit and a buffer for converting read-command information provided from the access module 200A to a read command, which is to be transmitted to the nonvolatile memory banks 112 to 142. The interface circuit included in the memory controllers is the same as an interface circuit mounted on a commercially available memory card (for example, a secure digital (SD) card), and thus will not be described.

### 1.1.2 Access Module 200A

Each block of the access module 200A will now be described in detail with reference to FIG. 1B. Play data is generated in accordance with, for example, a stroke operation performed on a master keyboard 300 included in an external unit. The CPU 230A obtains the play data via the input/output unit 210A.

The input/output unit 210A includes a terminal through which the play data is input from the master keyboard 300, a DA converter for converting music sound generated by the signal processing unit 220 through digital to analogue conversion, an amplifier unit for amplifying the music sound resulting from the conversion, and a line out terminal for outputting an output of the amplifier unit to outside.

The signal processing unit 220 generates music sound by processing music sound, which has been obtained using 32 channels at a maximum and provided from the CPU 230A, through interpolation calculation and level control, and then subjecting the data to effects processing, such as mixing of sound generation channels and adding of reverb effects. The signal processing unit 220 includes a digital signal processor (DSP), a ROM storing programs to be executed by the DSP, and a RAM for a delay element used in the effects processing or for temporarily storing parameters.

The CPU 230A performs the channel assigning processing for play data received from the input/output unit 210A, and transmits, to the read command unit 240, a request for reading data from the nonvolatile storage modules 110A to 140A. The CPU 230A receives music sound data read by the read command unit 240 from the nonvolatile storage modules 110A to 140A, and provides the music sound data and a part of the play data to the signal processing unit 220.

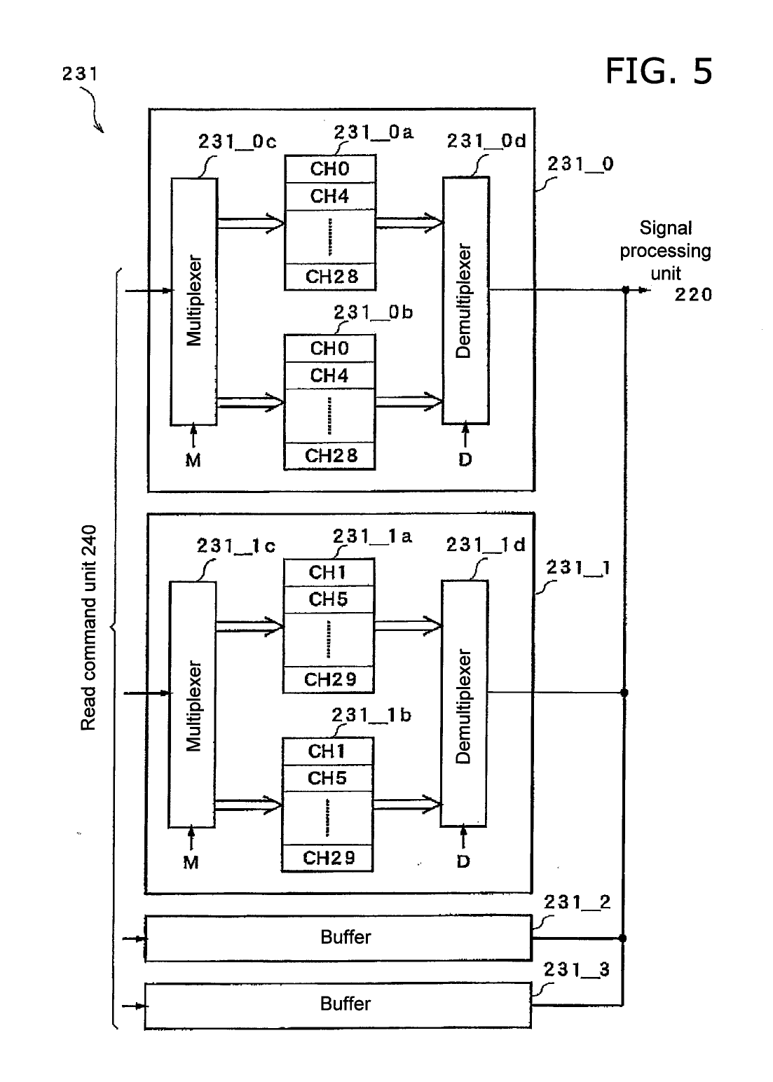

FIG. 5 is a block diagram of the music sound data buffer 231 included in the CPU 230A. The music sound data buffer 231 includes four buffers 231_0 to 231_3. Each of the four buffers has the same internal circuit configuration. The four buffers are used for different music generation channels as described in (a) to (d) below.

(a) The buffer 231_0 is used to temporarily store music sound data corresponding to channels CH0, CH4, CH8, CH12, CH16, CH20, CH24, and CH28.

(b) The buffer 231_1 is used to temporarily store music sound data corresponding to channels CH1, CH5, CH9, CH13, CH17, CH21, CH25, and CH29.

(c) The buffer 231_2 is used to temporarily store music sound data corresponding to channels CH2, CH6, CH10, CH14, CH18, CH22, CH26, and CH30.

(d) The buffer 231_3 is used to temporarily store music sound data corresponding to channels CH3, CH7, CH11, CH15, CH19, CH23, CH27, and CH31.

The buffer 231_0 includes dual port RAMs 231_0a and 231_0b, a multiplexer 231_0c, and a demultiplexer 231_0d. The dual port RAMs 231_0a and 231_0b each have a capacity of 4 kilobytes, and each can temporarily store data corresponding to the eight channels CH0, CH4, CH8, . . . to CH28. These RAMs each have a storage capacity of 512 bytes per channel. The buffer 231_1 includes dual port RAMs 231_1a and 231_1b, a multiplexer 231_1c, and a demultiplexer 231_1b. The dual port RAMs 231_1a and 231_1b each have a capacity of 4 kilobytes, and each can temporarily store data corresponding to the eight channels CH1, CH5, CH9, . . . to CH29. These RAMs each have a storage capacity of 512 bytes per channel. The other buffers 231_2 and 231_3 have the same structure as these buffers, and are used for the corresponding channels.

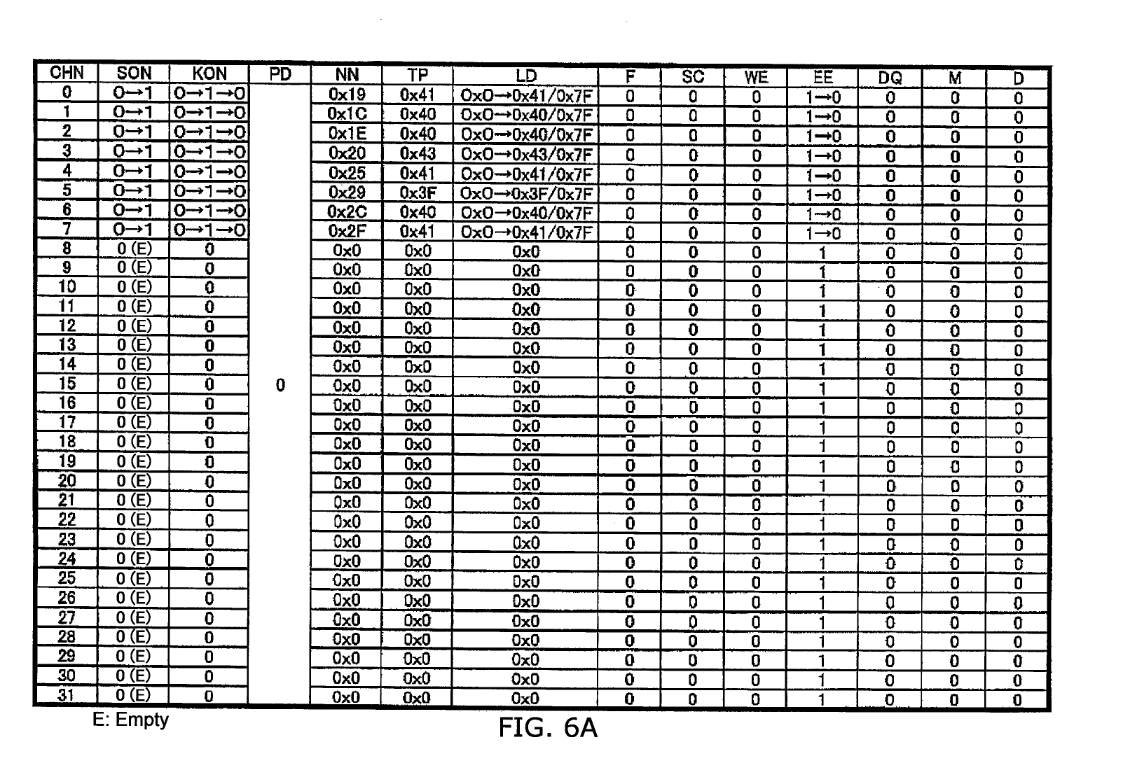

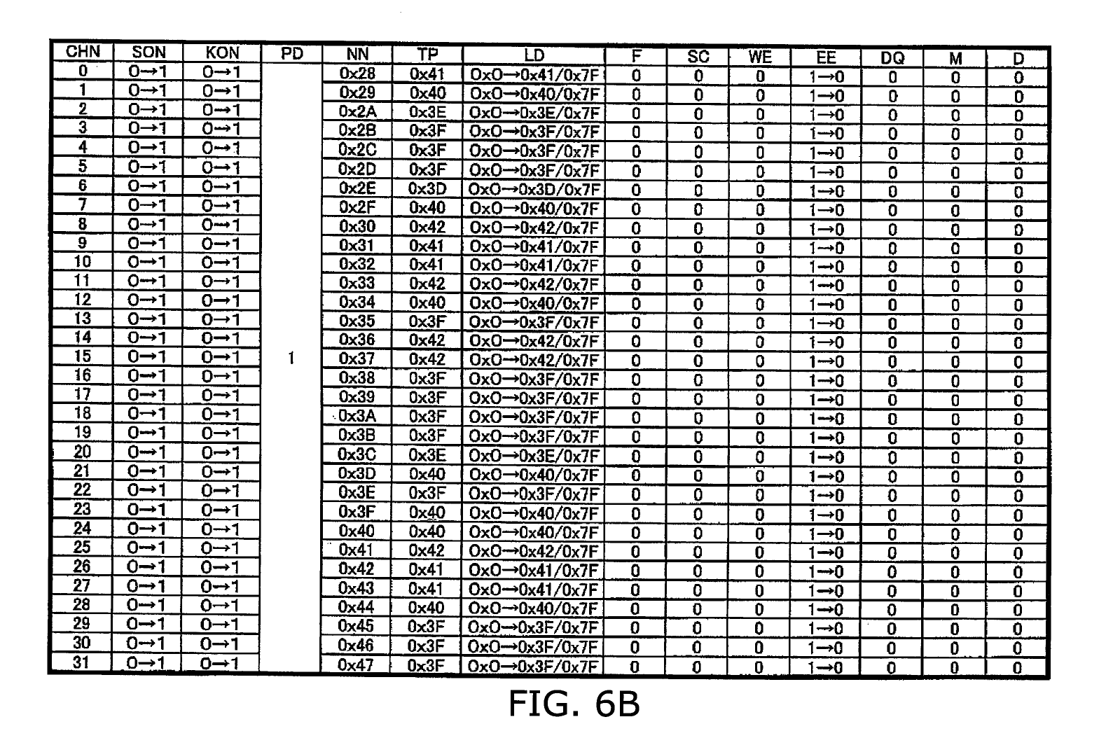

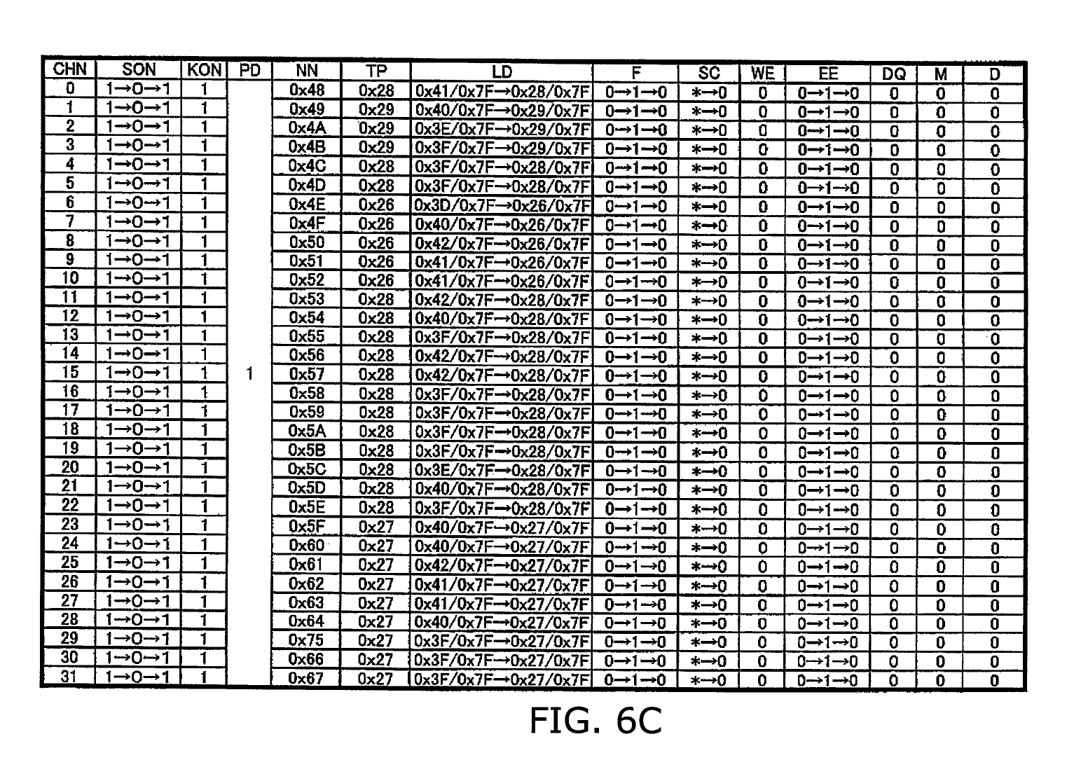

FIGS. 6A to 6C schematically show the channel assign table 232 included in the CPU 230A. The channel assign table 232 stores information about the status of each of all the channels CH0 to CH31, or for example the sound generation status of each channel. The information stored in the channel assign table 232 will now be described.

A sound generation flag SON indicates whether sound is being generated using the corresponding channel. The flag SON set to 0 indicates that sound is being generated using the corresponding channel, whereas the flag SON set to 1 indicates that the corresponding channel is unoccupied.

A flag KON is set to 1 during a period from when a key is struck to when the key is released.

A note number NN is a hexadecimal number corresponding to the position of a key of a piano.

A touch parameter TP represents touch strength information corresponding to the strength of the key touch.

Level data LD indicates the volume of music sound that is determined by the strength of the key touch.

A compulsory sound elimination flag F is used to eliminate music sound compulsorily.

A sector counter SC counts up every time when a single sector of music sound data, or specifically 128 samples of music sound data, are read.

A wave end flag WE is used to indicate that a last sample of music sound data, which is sample s1763999, has been processed to generate music sound.

An envelope end flag EE is set to 1 when the volume of music sound decreases to a level at which a change in the music sound volume that occurs in accordance with the state of the key stroke or the state of the sustaining pedal (hereafter referred to as an “envelope ENV”) cannot be perceived by the human ear.

A music sound data read request flag DQ is set when the number of samples of music sound data that has been processed by the signal processing unit 220 to generate music sound reaches a predetermined threshold (for example, 96 samples).

A selection flag M is used to select one of the dual ports RAMs 231_0a and 231_0b included in the buffer 231_0 of the music sound data buffer 231 into which music sound data is to be written. The same applies to the buffers 231_1 to 231_3 of the music sound data buffer 231.

A selection flag D is used to select one of the dual ports RAMs 231_0a and 231_0b included in the buffer 231_0 from which music sound is to be transferred to the signal processing unit 220. The same applies to the buffers 231_1 to 231_3 of the music sound data buffer 231. For the buffer 231_0, the dual port RAM 231_0a is selected when the flags D and M are set to 0, and the dual port RAM 231_0b is selected when the flags D and M are set to 1. The same applies to the buffers 231_1 to 231_3.

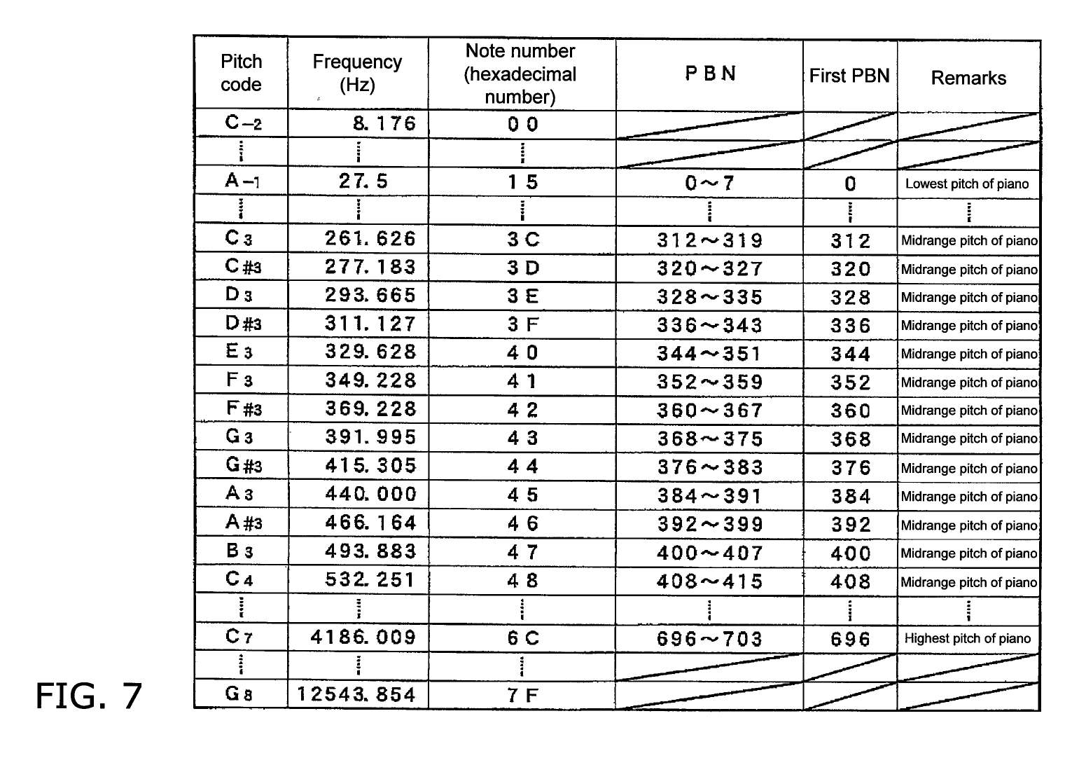

FIG. 7 schematically shows the NN table 233A stored in the CPU 230A. The NN table shows the correspondence between the note number NN and the block number of the physical block storing music sound data identified by the note number NN.

The play data buffer 234 is a first-in, first-out (FIFO) memory for storing a plurality of pieces of play data that are input from the master keyboard 300.

The transfer monitoring unit 235 included in the CPU 230A monitors the data transfer, and transmits a transfer completion flag TRNF to the signal processing unit 220 when determining that the temporary storing of data into an area corresponding to any channel of one of the two buffers 231_0 to 231_3 is completed.

The read command unit 240 transfers read-command information to the nonvolatile storage modules 110A to 140A in accordance with the access status of the nonvolatile storage modules 110A to 140A in response to a read request transmitted from the CPU 230A.

The read command unit 240 includes a channel register 241 and an MM register 242.

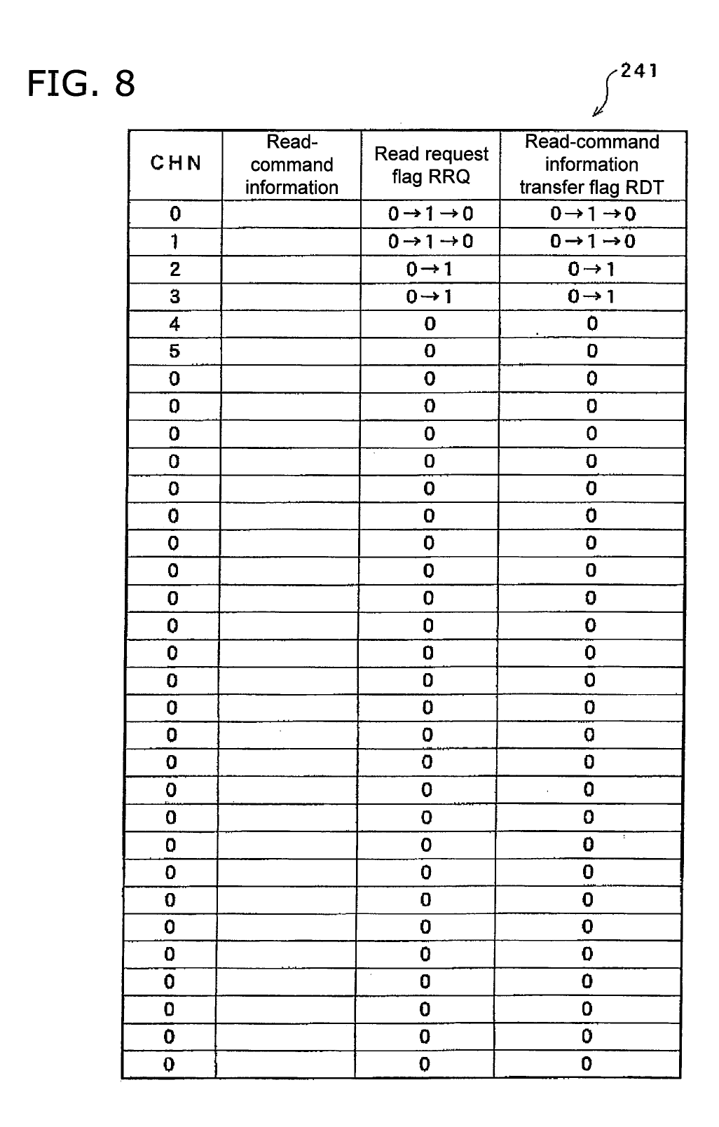

FIG. 8 shows a memory map of the channel register 241 included in the read command unit 240. The channel register 241 shows the read command transmission status for the 32 channels. More specifically, the channel register 241 stores read-command information, a read request flag RRQ, and a read-command-information transfer flag RDT for each of the 32 channels.

The read request flag RRQ is set to 0 when the CPU 230A has no read request, and is set to 1 when the CPU 230A has transmitted a read request.

The read-command-information transfer flag RDT is set on when the read command unit 240 has transmitted read-command information to any of the nonvolatile storage modules 110A to 140A. The flag RDT is reset when the read command unit 240 no longer has a read request.

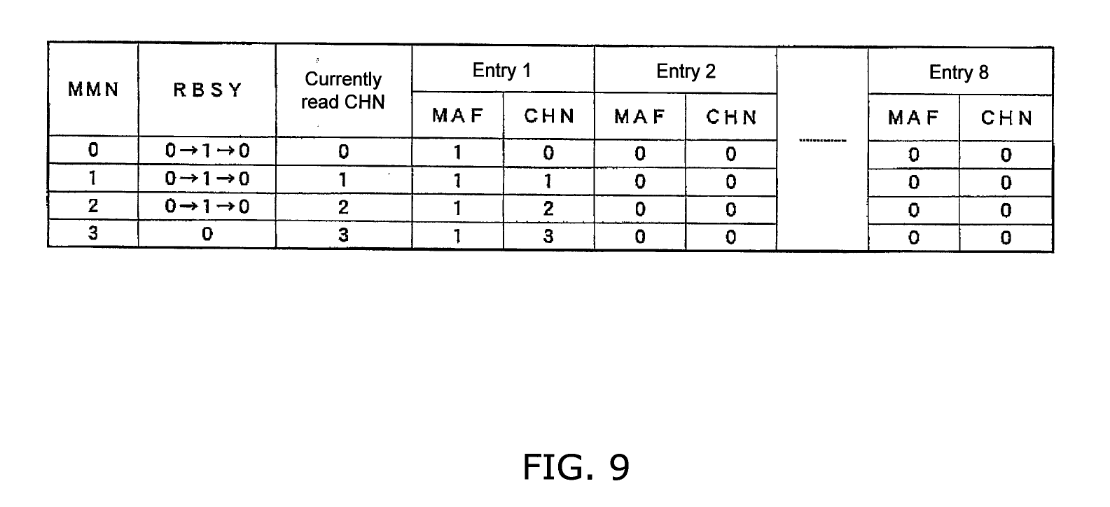

FIG. 9 shows a memory map of the MM register 242 included in the read command unit 240. The MM register 242 shows the access status of the nonvolatile storage modules 110A to 140A. The MM register 242 stores a reading flag RBSY for the four nonvolatile storage modules 110A to 140A. The nonvolatile storage module 110 corresponds to MMN of 0 (hereafter referred to as “MM0”), the nonvolatile storage module 120 to MMN of 1 (hereafter referred to as “MM1”), and the nonvolatile storage module 130 to MMN of 2 (hereafter referred to as “MM2”), and the nonvolatile storage module 140 to MMN of 3 (hereafter referred to as “MM3”). The reading flag RBSY is set to 1 when the read command unit 240 transfers read-command information to the nonvolatile storage modules 110A to 140A, and is reset to 0 when data (of 512 bytes) corresponding to the read-command information is read from the nonvolatile storage modules 110A to 140A.

The MM register 242 also includes eight entries 1 to 8 for each of the nonvolatile storage modules MM0 to MM3. The entries 1 to 8 each include a module assign flag MAF and a channel number CHN. The flag MAF set to 1 indicates that read-command information has been transferred to the corresponding nonvolatile storage module and sound is being generated using the corresponding channel. The flag MAF is reset to 0 when the sound generation performed using the corresponding channel is stopped. The channel number CHN indicates the channel number of the channel with which sound is being generated. Each of the nonvolatile storage modules 110A to 140A can receive read-command information for eight channels at a maximum.

### Initial State

Before shipment, the storage module 100A or the music sound generation system shown in FIGS. 1A and 1B is initialized by the manufacturer. This initialization of the storage module 100A or the music sound generation system performed by the manufacturer will now be described. In the present embodiment, music sound data of the piano is digitally recorded at a sampling frequency of 44.1 kHz. For each pitch, music sound data of about 40 seconds is stored in each of the nonvolatile storage memory banks 112 to 142 without being compressed. The time required by the sound generated after the piano key is struck to attenuate sufficiently is assumed to be 40 seconds from the key stroke timing. In this case, the system generates 1764000 samples of music sound data as given by expression (4).

44.1 [kHz]*40 [second]=1764000 [sample] Expression (4)

In this example, two types of music sound data of the piano corresponding to 88 keys, one with the strongest touch and the other with the weakest touch, are digitally recorded in advance. As shown in FIG. 2, the two types of music sound data are written into the physical blocks PB0 to PB703 of the nonvolatile memory bank 112 in ascending order of the piano pitches from the lowest pitch to the highest pitch. The same data is also recorded in each of the nonvolatile memory banks 112 to 142. In this manner, the same data is stored in a multiplex manner in the four nonvolatile memory banks that are arranged parallel to one another.

The lowest pitch data of the piano is stored into the physical blocks PB0 to PB7 of each memory bank. The 1764000 samples of music sound data, or the samples from the first sample (s0), which is generated immediately after the key stroke, to the last sample (s1763999), are stored into the pages of these physical blocks in ascending order of the pages of the physical blocks from the page P0 of the physical block PB0. As shown in FIG. 3, the two sets of music sound data, or the data with the weakest touch and the data with the strongest touch, are written in a manner that such pairs the weakest touch data and the strongest touch data are arranged in units of 512 bytes.

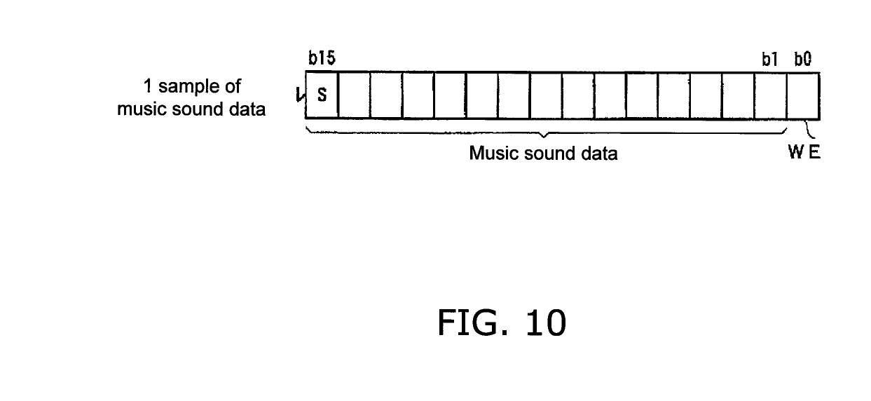

FIG. 10 shows a bit format of a single sample of music sound data. In FIG. 10, bit b15 carries a sign bit representing either a positive sign or a negative sign. The single sample of music sound data consists of fifteen bits from bits b15 to b1. Bit b0 carries the wave end flag WE. The flag WE indicates whether the corresponding sample is the last sample. The flag WE set to 1 indicates that the corresponding sample is the last sample.

At the time of initialization, information about the property of music sound data of the piano recorded in the storage module 100A (hereafter referred to as “recorded-data property information”) and information about the memory structure of the storage module 100A (hereafter referred to as “memory structure information”) are written into the page P0 included in the last physical block PB1023 of the nonvolatile memory bank 112.

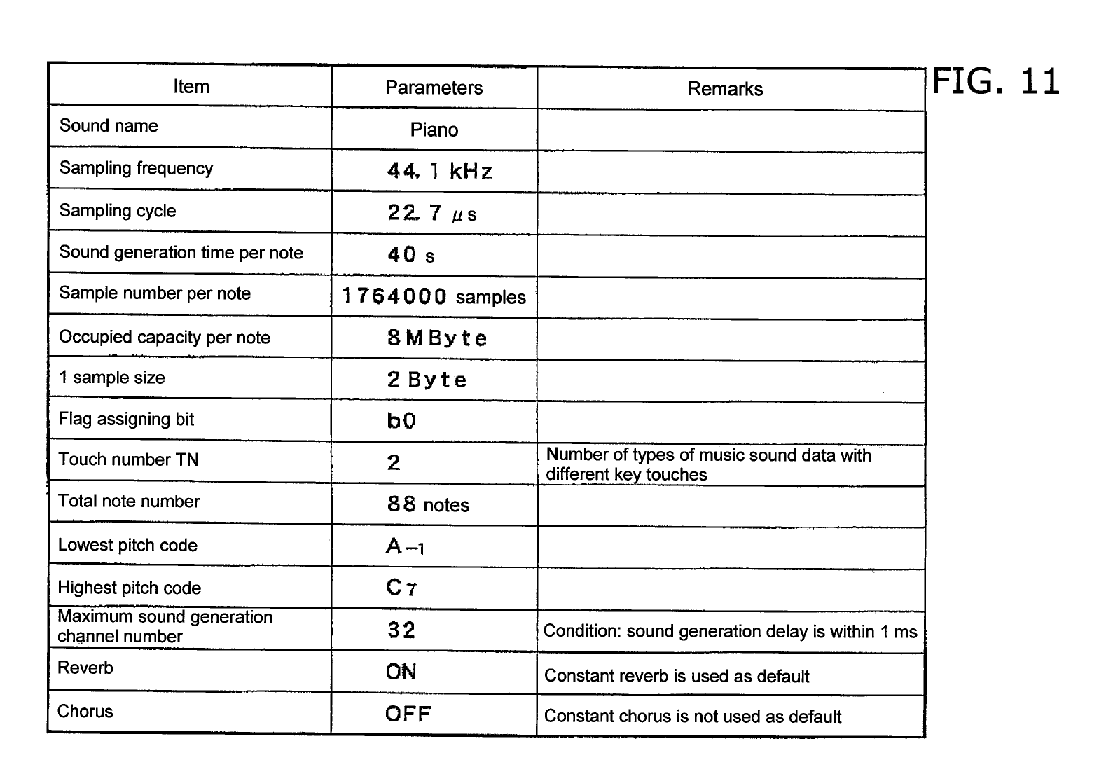

FIG. 11 schematically shows an example of the recorded-data property information. The property information includes at least information about the sampling frequency (44.1 kHz in this example) of the music sound data. The reverb field and the chorus field are used when the effects processing is performed. In the table shown in FIG. 11, information included in the remarks column is not actually recorded, but is provided as reference information.

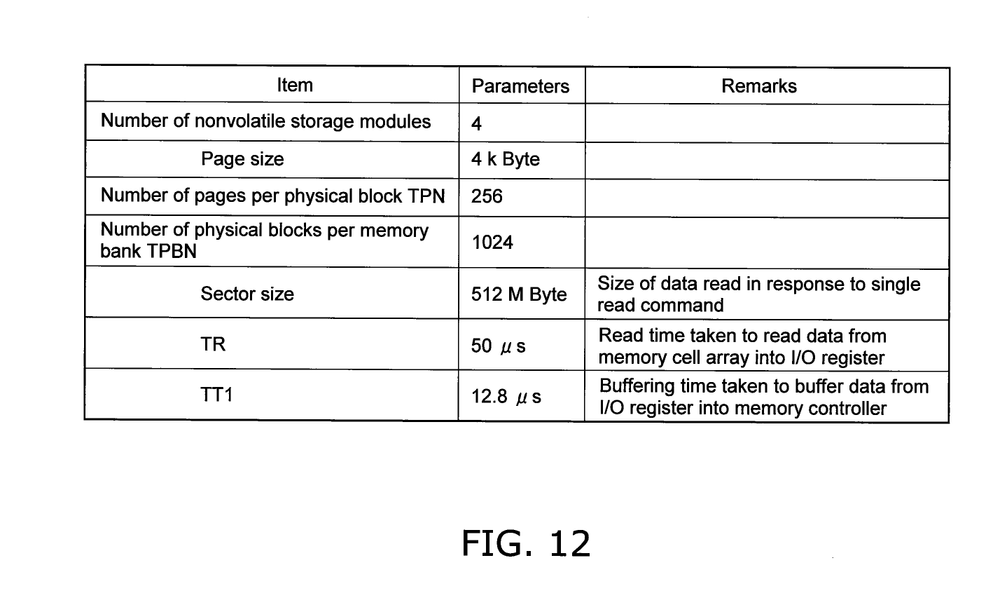

FIG. 12 schematically shows an example of the memory structure information of the storage module 100A. In FIG. 12, the sector size indicates the size of data that is read in response to every single read command. The read time TR indicates the time required to read data from the memory cell array to the I/O register. The transfer time TT1 indicates the time required to buffer data from the I/O register included in each memory bank into the memory controller. In the table in FIG. 12, information included in the remarks column is not the actually recorded information, but is provided as reference information.

### 1.2 Operation of Music Sound Generation System

The operation of the music sound generation system with the above-described structure according to the first embodiment will now be described.

1.2.1 Initialization Performed when System is Powered On

When powered on, the access module 200A and the storage module 100A start initialization. Each storage module included in the storage module 100A is initialized by the corresponding memory controller. When the initialization of the storage module 100A is completed, the access module 200A is permitted to access the storage module 100A. The initialization performed by the memory controllers is the typical processing known in the art, and will not be described.

The access module 200A is initialized through the processing performed by the CPU 230A and the processing performed by the read command unit 240.

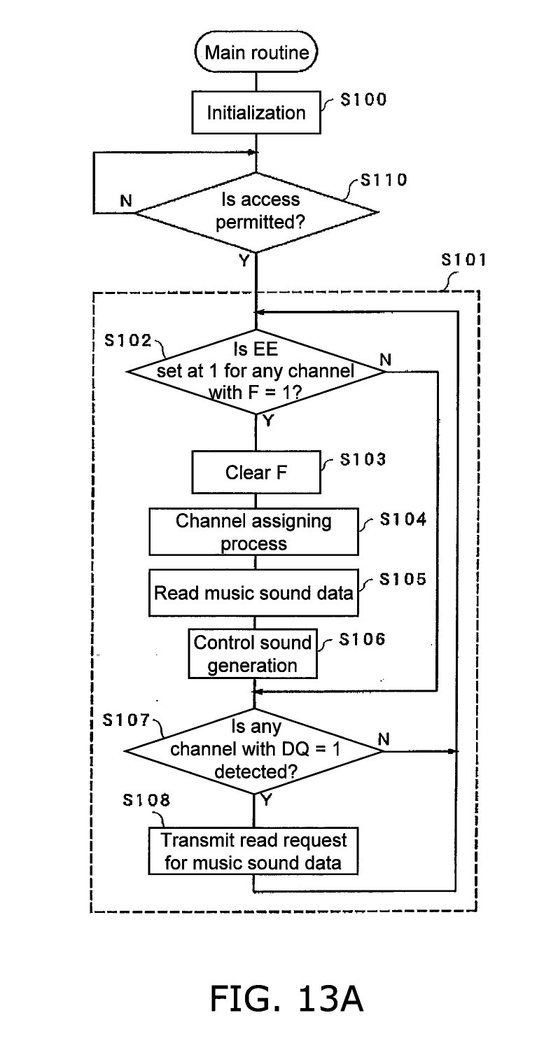

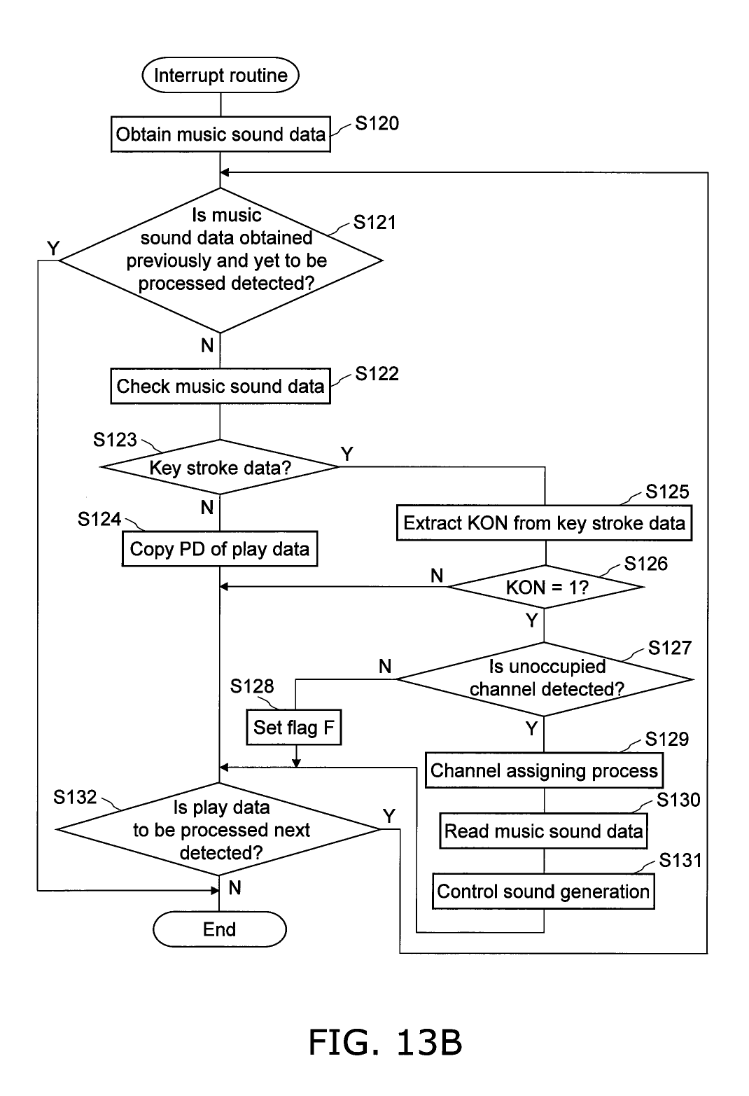

As shown in the flowchart of FIG. 13A, the CPU 230A included in the access module 200A performs the initialization in step S100. In the initialization, the CPU 230A resets the signal processing unit 220 and clears the dual port RAMs included in the buffers 231_0 to 231_3 of the music sound data buffer 231. When reset, the signal processing unit 220 starts counting up the program counter included in its internal DSP. The CPU 230A also performs the initial settings of the channel assign table 232 shown in FIGS. 6A to 6C. More specifically, the CPU 230A performs the settings below:

(1) It sets SON to 0, or sets the channels CH0 to CH31 to unoccupied status.

(2) It sets KON, PD, NN, TP, LD, F, SC, WE, DQ, M, and D to 0.

(3) It sets EE to 1.

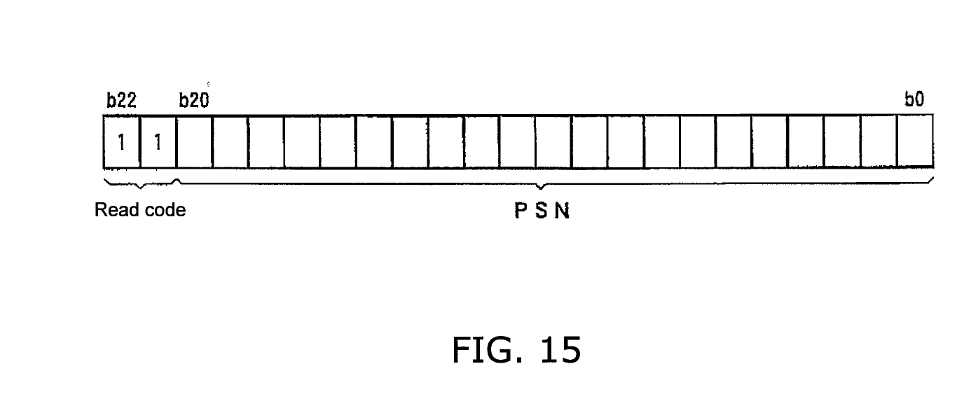

Subsequently, the access module 200A transfers read-command information, which is information representing a command for reading the recorded-data property information and the memory structure information, to the nonvolatile storage module 110A. FIG. 15 shows a bit format of the read-command information transferred from the access module 200A to the nonvolatile storage module 110. The bit format includes bits b22 and b21 that can be used to extend this command to a command other than the read command. In the present embodiment, these bits are fixed to indicate 11 because no command other than a read command is used in the present embodiment. The property information is stored in an area of 512 bytes from the 0^{th} address of the page P0 of the physical block PB1023 included in the nonvolatile memory bank 112. The access module 200A transfers the read-command information to the nonvolatile storage module 110 to read the recorded-data property information and the memory structure information.

The CPU 230A obtains the recorded-data property information shown in FIG. 11, and then sets the sampling frequency (22.7 μs) with the timer included in the signal processing unit 220, and determines the cycle of time slots for signal processing performed during the single sampling time. This timer functions to control the cycle of the DSP included in the signal processing unit 220. The CPU 230A writes the single sampling capacity (2 bytes) included in the recorded-data property information and the flag assigning bit (b0) as a parameter for the RAM included in the signal processing unit 220, and uses the parameter to determine the bit positions corresponding to the music sound data in the bit format shown in FIG. 10.

The CPU 230A further determines usable channels included in the channel assign table 232 based on the maximum sound generation channel number (32 channels) included in the recorded-data property information, and also determines the number of channels corresponding to the time slots of the signal processing unit 220. The signal processing unit 220 also determines the effects processing using the reverb field and the chorus field. In the example shown in FIG. 11, the signal processing unit 220 determines that only the processing for adding the reverb effects is to be performed as the effects processing.

The CPU 230A further obtains the memory structure information shown in FIG. 12, and calculates the number of nonvolatile storage modules from which data can be read in parallel (parallel module number) based on the number of nonvolatile storage modules using expression (5).

Parallel module number=Number of nonvolatile storage modules Expression (5)

The maximum number of channels that are assigned to a single nonvolatile storage module, or in other words the maximum number of channels for which the read-command information is transferred (the maximum number of channels per module) is given by expression (6).

Maximum number of channels per module=number of channels (CHN)/parallel module number Expression (6)

In the present embodiment, the number of channels is 32, and the parallel module number is 4. In this case, read-command information corresponding to eight channels at a maximum can be assigned to each of the nonvolatile storage modules 110A to 140A based on expression (6). The correspondence between each channel and the nonvolatile storage module to which the channel is assigned will be described later.

The CPU 230A refers to the sector size (512 bytes) included in the memory structure information shown in FIG. 12, and manages data using the unit size of data that can be read from the storage module 100A as 512 bytes. The CPU 230A also determines the total number of samples per sector (hereafter referred to as “usn”) using expression (7).

usn=sector size/size of one sample/number of touches Expression (7)

In the present embodiment, the sector size is 512 bytes, the size of one sample is 2 bytes, and the number of touches is 2. As a result, usn=128 samples.

The CPU 230A further calculates the number of physical blocks required per note based on the occupied capacity of the recorded-data property information shown in FIG. 11 per note, the page size and the page number TPN per physical block (256 in this case) included in the memory structure information using expression (8).

Number of physical blocks required per note=occupied capacity per note/(page size*TPN)=8 Expression (8)

The CPU 230A then determines the physical block number PBN corresponding to each of the notes from the lowest pitch A-1 to the highest pitch C7, and generates the NN table 233A shown in FIG. 7.

Through this main routine, the CPU 230A reads the recorded-data property information and the memory structure information and sets the parameters, and completes the initialization (S100).

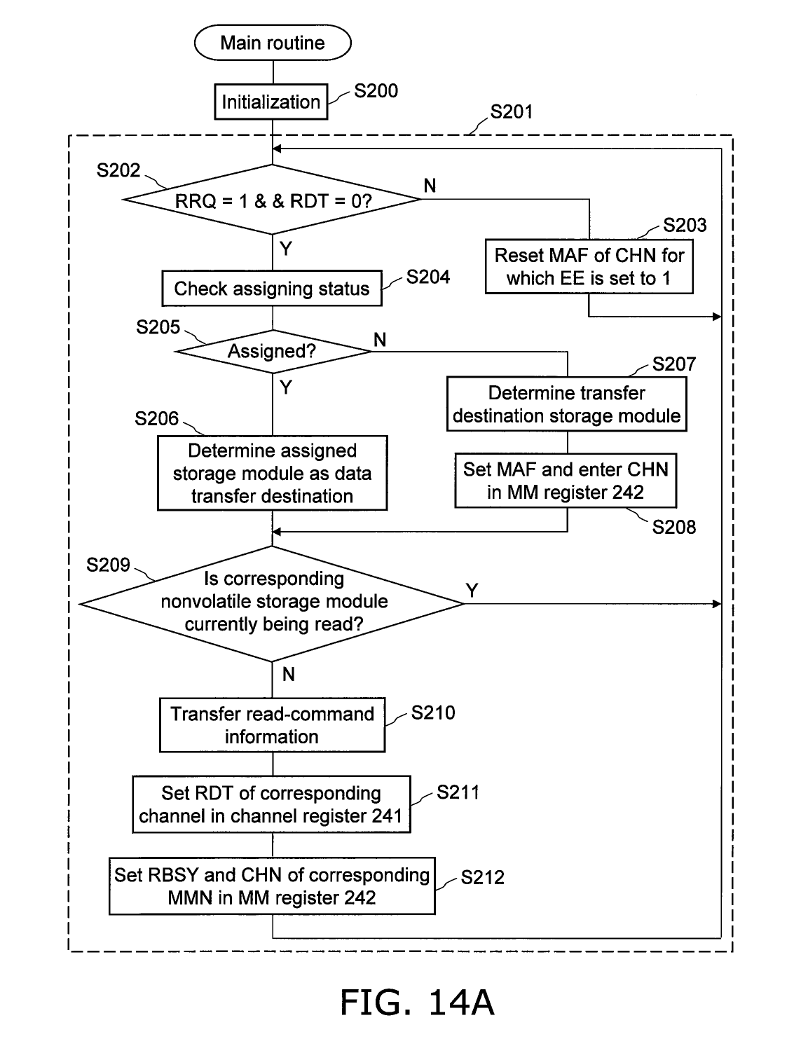

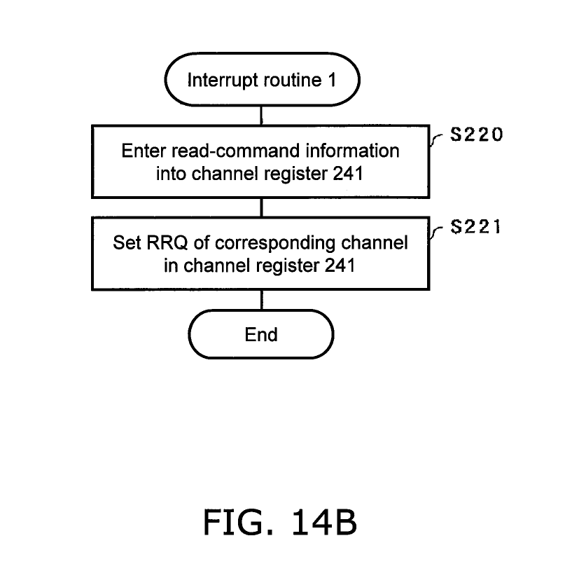

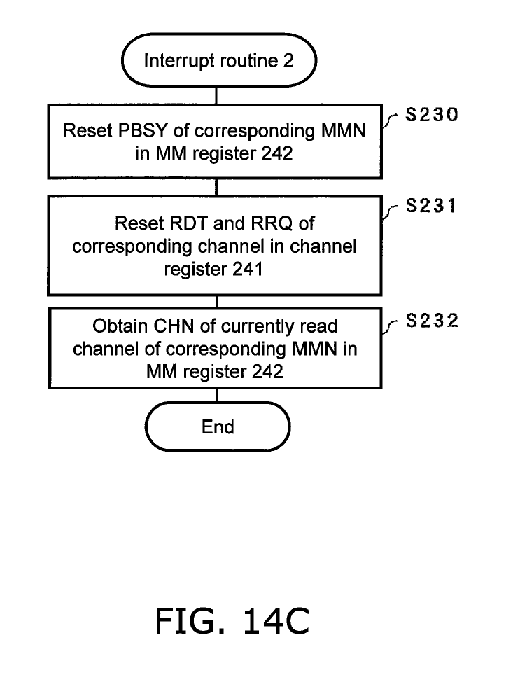

FIG. 14A is a flowchart showing the normal processing performed by the read command unit 240. FIGS. 14B and 14C are flowcharts showing interrupt processing that is performed as an interrupt of the normal processing.

As shown in the flowchart of FIG. 14A, the read command unit 240 performs the initialization in step S200. During the initialization, when receiving an access permission from all the nonvolatile storage modules of the storage module 100A, the read command unit 240 provides notification about the access permission to the CPU 230A.

When receiving the notification about the access permission from the read command unit 240, the CPU 230A shifts from the processing in step S110 to the normal processing in step S101, and enables an interrupt and waits for play data that is transmitted from the external master keyboard 300.

1.2.2 Processing Performed during Normal Operation

### (1) Overall Operation

The overall operation of the system performed from when play data is input to when music sound is generated will now be described mainly using the flowchart illustrating the processing performed by the CPU 230A and the flowchart illustrating the processing performed by the read command unit 240. The processing of the CPU 230A and the processing of the read command unit 240 are performed independently of each other.

FIG. 13B shows an interrupt routine that is executed by the CPU 230A. This interrupt routine is called when play data is transferred to the access module 200A after a playing operation is performed on the master keyboard 300. When the playing operation is performed on the master keyboard 300 while the main routine shown in FIG. 13A is being executed, the processing immediately shifts to the interrupt routine. Another interrupt routine can be executed in a multiplex manner while this interrupt routine is being executed. In other words, another interrupt can be called while one interrupt routine is being executed.

In the flowchart showing the processing performed by the read command unit 240, the interrupt routine consists of an interrupt routine 1 shown in FIG. 14B and an interrupt routine 2 shown in FIG. 14C. The interrupt routines 1 and 2 are given no order of priority. Also, another interrupt routine can be executed in a multiplex manner while each of these interrupt routines 1 and 2 is being executed. The interrupt routine 1 is called when a read request is transmitted from the CPU 230A. The interrupt routine 2 is called when music sound data is received from the storage module 100A.

When no operation of playing is performed on the master keyboard 300 after the processing shifts to the normal processing in step S101, the compulsory sound elimination flag F is set at 0 for all channels, and the read request flag DQ is set at 0 for all channels. In this case, the result of the determination performed at the branch in each of steps S102 and S107 is No. Subsequently, the branching process in each of steps S102 and S107 is performed permanently.

When an operation of playing is performed on the master keyboard 300, the interrupt routine shown in FIG. 13B is called. The interrupt processing performed in this case will now be described

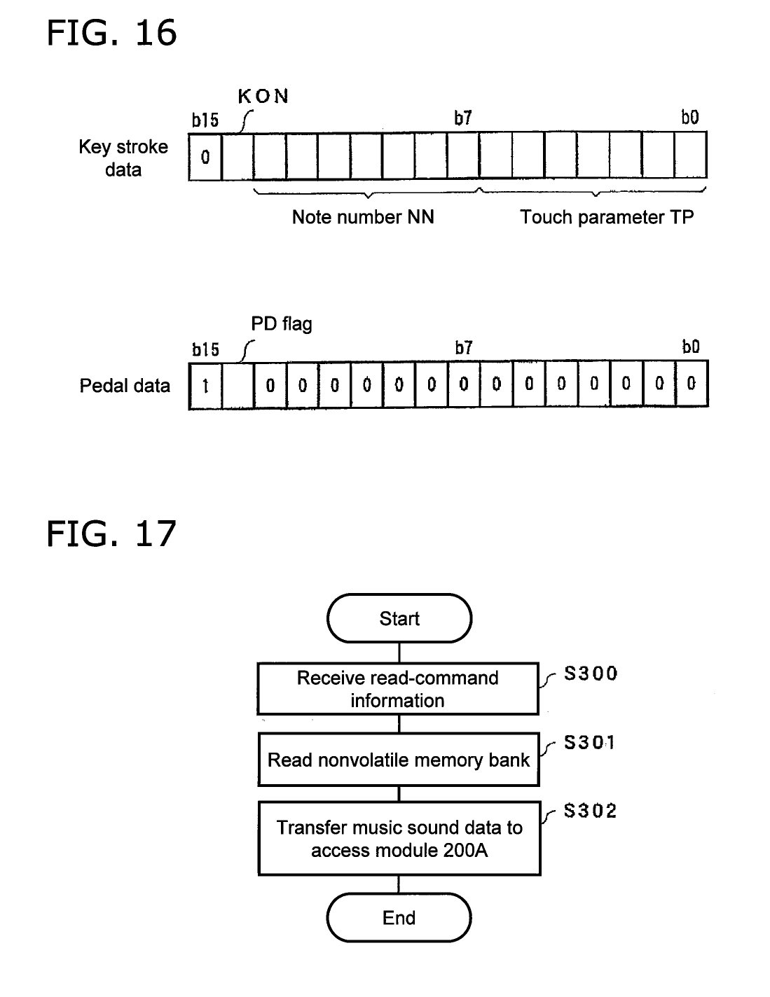

FIG. 16 shows a bit format of play data that is transferred from the master keyboard 300. The play data consists of two different sets of data: key stroke data and pedal data. The key stroke data is generated in accordance with a stroke operation of a key. The pedal data is generated in accordance with an on/off operation of the sustaining pedal. These sets of data are identified by the value of bit b15. The key stroke data includes the flag KON, the note number NN, and the touch parameter TP, which are described above. The pedal data includes a flag PD, which is set to 1 when the sustaining pedal is set on. The suspending pedal is used to sustain sound that has been generated for a key after the key is released. A real piano also has this pedal.

In the interrupt routine, the CPU 230A first obtains the play data that is transferred from the master keyboard 300 via the input/output unit 210A, and stores the play data into the play data buffer 234 (S120). The play data has either the format of key stroke data or the format of pedal data shown in FIG. 16. When the play data buffer 234 stores no play data that has been obtained previously and has yet to be processed (S121), the CPU 230A checks the obtained play data (S122). More specifically, the CPU 230A determines whether the play data is either key stroke data or pedal data by referring to bit b15 of the play data shown in FIG. 16. When the play data is pedal data (S123), the CPU 230A copies bit b14 of the pedal data as shown in FIG. 16, that is, the flag PD, directly as the value of the PD in the channel assign table 232 (S124), and advances to S132.

When the play data is key stroke data (S123), the CPU 230A extracts the flag KON from bit b14 of the key stroke data as shown in FIG. 16 (S125), and checks the value of the flag KON in step S126. When the value of the flag KON is 0, indicating that the key is being released, the CPU 230A advances to S132.

When the value of the flag KON is 1, indicating that the key has been struck, the CPU 230A determines whether the channel assign table 232 includes an unoccupied channel (S127). More specifically, the CPU 230A searches the channel assign table 232 for a channel for which the sound generation flag SON is set at 0 in ascending order of channels from the channel CH0. The CPU 230A assigns the play data to the first channel detected as a channel for which the flag SON is set at 0 (S129). In the channel assigning process, the CPU 230A sets the information about the channel to which the play data is to be assigned in the manner described below.

(1) It sets SON to 1.

(2) It copies NN and TP from the key stroke data.

(3) It sets SC, WE, EE, DQ, M, and D to 0.

After the channel assigning process, the CPU 230A transmits a read request together with the read-command information for music sound data shown in FIG. 15 to the read command unit 240. The read-command information is obtained in the manner described below.

(a) The first PBN is obtained by referring to the NN table 233A based on the number NN of the key stroke data.

(b) The number PSN is then calculated using expression (9) based on the first PBN and the SC.

PSN=(first PBN<<11)+SC Expression (9)

In the expression, & is an operator to calculate a logical AND, | is an operator to calculate a logical OR, and << is an operator for shifting bits to the left.

(c) The number PSN calculated using expression (9) has 21 bits, among which the two higher-order bits indicate 11. The read-command information can be obtained using expression (10). In the expression, “0x” indicates that the notation is hexadecimal. FIG. 15 shows the read-command information.

Read-command information=0x600000|PSN Expression (10)

In the manner described above, the CPU 230A determines the number PSN of a physical sector from which data is to be read, and transfers the read-command information having the format shown in FIG. 15 to the read command unit 240. When receiving the read request, its associated CHN, and the read-command information, the read command unit 240 enters the received CHN and the received read-command information into the channel register 241. Subsequently, the read command unit 240 determines a target nonvolatile storage module from which data is to be read by referring to the MM register 242. When no music sound data is currently being read, the read command unit 240 transfers the read-command information entered in the channel register 241 to the target nonvolatile storage module. Desired music sound data will be read from the target nonvolatile storage module based on the transferred read-command information.

Reading of Music Sound Data from Storage Module 100A Caused by Read Command Unit 240

Reading of music sound data from the storage module 100A that is caused by the read command unit 240 will now be described using mainly the flowcharts shown in FIGS. 14A to 14C and FIG. 17.

The read command unit 240 first performs the initialization described above (S200) in the main routine shown in FIG. 14A, and then shifts to the normal processing (S201). When no read request is transmitted from the CPU 230A, the flag RRQ is set at 0 for all channels in the channel register 241. In this case, the read command unit 240 monitors changes in the flag EE that is managed by the CPU 230A, and adjusts the flag settings of the MM register 242 in accordance with the monitoring results (5203). More specifically, when the value of the flag EE for any channel having the flag MAF set at 1 in the MM register 242 changes from 0 to 1, or in other words when the status of such a channel changes from the sound generating status to the no-sound status, the read command unit 240 resets the flag MAF to 0 and excludes this channel from the entries. The processing then returns to S202. Subsequently, the branching process in each of steps S202 and S203 is performed permanently.

When receiving a read request from the CPU 230A, the read command unit 240 shifts the processing from the loop of the main routine consisting of steps S202 and S203 to the interrupt routine 1 shown in FIG. 14B. In the interrupt routine 1, the read command unit 240 enters the read-command information into the channel register 241, and enters the channel number CHN transferred together with the read-command information into the CHN field of the channel register 241 (S220). The read command unit 240 then resets the flag RRQ corresponding to the channel number CHN to 1 (S221). This completes the interrupt routine. The processing then returns to the main routine. In the example shown in FIG. 8, the read command unit 240 receives a read request associated with the channels CH0 to CH3 from the CPU 230A, and then changes the flag settings through the processing that will be described later. FIG. 8 shows the state of the channel register 241 after music sound data is completely transferred from the nonvolatile storage modules 110A and 120A to the access module 200A in response to the read-command information that has been transferred to the nonvolatile storage modules 110A to 140A together with the read request associated with the channels CH0 to CH3. After the music sound data is transferred, the read command unit 240 changes the settings of the flags in the channel register 241. The read command unit 240 also changes the settings of the flags in the MM register 242 (FIG. 9) including the flag RBSY indicating whether the nonvolatile storage modules (MM0 to MM3) are currently being read.

In the main routine shown in FIG. 14A, the flag RRQ is set to 1 for the channels CH0 to CH3. The processing then advances from S202 to S204. The read command unit 240 checks the assigning status based on the MM register 242, or determines whether the read-command information corresponding to CH0 to CH3 has been assigned (transferred) to a nonvolatile storage module. More specifically, the read command unit 240 checks the entries 1 to 8 corresponding to each nonvolatile storage module, and determines that the read-command information has already been assigned to a nonvolatile storage module when the flag MAF for the nonvolatile storage module is set at 1 for any of the channels CH0 to CH3 in step S205. The read command unit 240 then determines, as a target nonvolatile storage module to which the read-command information is to be transferred, the nonvolatile memory module for which the flag MAF is set at 1 for any of the channels CH0 to CH3 (S206).

When the read-command information has yet to be assigned to any nonvolatile storage module, the read command unit 240 counts the number of entries (entry number) for which the flag MAF is set at 1 in the MM register 242 in step S207. The read command unit 240 then determines a nonvolatile storage module with the least number of such entries as a target nonvolatile storage module to which the read-command information is to be transferred. When a plurality of nonvolatile storage modules have the least number of such entries, the read command unit 240 selects one of the nonvolatile storage modules having a smaller size. Subsequently, the read command unit 240 selects one of the entries for which the flag MAF has been set to 0 and sets the flag MAF of the selected entry to 1, and at the same time enters the number CHN of the channel to be assigned into the CHN field (S207). In the initial status, all the entries of the MM register 242 are blank. In this case, the read command unit 240 enters the channels CH0 to CH3 into the entry 1 corresponding to MN0 to MN3 as shown in FIG. 9.

The read command unit 240 subsequently refers to the reading flag RBSY in the MM register 242, and determines whether the nonvolatile storage modules 110A to 140A are currently being read (S209). In the initial status, the flag RBSY is set to 0 for all channels in the MM register 242. In this case, none of the nonvolatile storage modules 110A to 140A is currently being read. The processing advances to S210 to perform processing for the channel CH0.

The read command unit 240 then transfers a read command corresponding to the channel CH0 to the nonvolatile storage module 110 (S210), and sets the flag RDT for the corresponding channel to 1 in the channel register 241 (S211). The read command unit 240 further sets the flag RBSY for the corresponding storage module (MM0) to 1 in the MM register 242, and sets 0 into the currently read CHN field of the storage module MM0 (S212). This indicates that music sound data is currently being read using the channel CH0 from the nonvolatile storage module 110.

The processing described above is performed for channels for which the flag RRQ is set at 1 in the channel register 241, that is, for the channels CH0 to CH3.

FIG. 17 is a flowchart showing the processing performed by each memory controller. When receiving read-command information (S300), the memory controller outputs a read command to the nonvolatile memory bank using the physical sector number PSN included in the read-command information as a read target address (S301). Music sound data read in response to this command is then transferred to the access module 200A (S302).

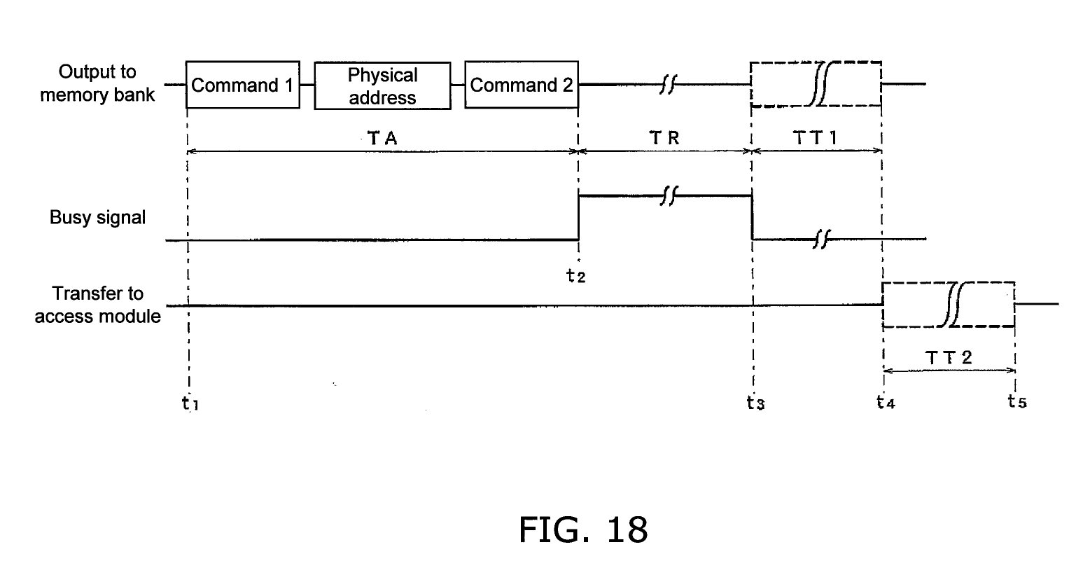

FIG. 18 is a timing chart for the read command that is transmitted from the memory controller to the nonvolatile memory bank. The read command consists of a command 1, which carries notification about when to subsequently start transferring a physical address, and a command 2, which causes music sound data stored at the physical address to be read from the memory cell array into the I/O register.

As shown in FIG. 18, the command 1 is output at timing t1, and a physical address is output immediately after the command 1 is output, and then the command 2 is output. The addressing time TA is about several hundred nanoseconds, which is negligible.

The physical address in FIG. 18 is an address designated in units of 512 bytes using the physical block number PBN, the page number, and the page-sector selecting bit in FIG. 4. The physical address designates the start address (in units of bytes) of the music sound data to be read. Music sound data stored at this start address to the last address of the corresponding page is read into the corresponding I/O register during the read time TR. Subsequently, 512 read clocks are provided during the transfer time TT1. As a result, the desired music sound data of 512 bytes is read from the I/O register into the memory controller.

The read command unit 240 transmits read-command information corresponding to the channels CH0 to CH3 to the nonvolatile storage modules 110A to 140A. This causes the flag RDT to be set to 0 for all the channels CH0 to CH3. As a result, the determination at the branch of step S202 to step S203 in FIG. 14A causes the branching process to be looped again.

The access module 200A temporarily stores the transferred music sound data into the music sound data buffer 231 via the read command unit 240. When detecting that the music sound data of 512 bytes (1 sector) has been received, the read command unit 240 shifts its control to execute the interrupt routine 2 shown in FIG. 14C. In the interrupt routine 2, the read command unit 240 resets the flag RBSY to 0 for the corresponding MMN in the MM register 242 (S230), and resets the flags RDT and RRQ to 0 for the corresponding channel CHN in the channel register 241 (S231). Further, the read command unit 240 obtains the channel number CHN of the currently read channel of the corresponding MMN in the MM register 242 (S232), and determines the buffer used to temporary store the received music sound data in the music sound data buffer 231.

An area in which the flag RRQ is set to 0 in the channel register 241 is a released area for new read-command information to be stored subsequently. When the flag RRQ is set at 0, the flag RDT is also set at 0 through the processing in step S231, and the flag RBSY in the MN register 242 is also set at 0 through the processing in step S230. When the read-command information is entered into the channel register 241, areas of the channel register 241 are used sequentially from the uppermost area to the lowermost area and then again from the uppermost area, or in other words the areas are used cyclically.

When receiving music sound data from any of the nonvolatile storage modules, the access module 200A temporarily stores the music sound data into an area of the music sound data buffer 231 corresponding to the CHN added to the music sound data.

The transfer time TT2 required to transfer music sound data from the memory controller to the music sound data buffer 231 will now be described. The transfer time TT2 is a parameter determined by the specifications of the access module 200A, and depends on the frequency of a clock signal (not shown) that is transmitted from the access module 200A to the storage module 100A via an external bus. In the present embodiment, the external bus connecting the access module 200A and each of the nonvolatile storage modules 110A to 140A has a width of 1 byte. The data is transferred on the external bus at a transfer frequency of 40 MHz. In this case, the transfer time TT2 is calculated to be about 12.8 microseconds using expression (11).

512 bytes*25 nanoseconds/byte=12.8 microseconds. Expression (11)

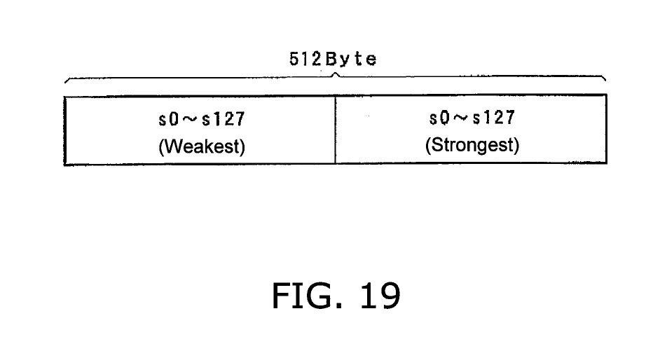

The music sound data read from one of the nonvolatile storage modules 110A to 140A in response to the transferred read-command information is transferred to the CPU 230A via the read command unit 240. In this example, the music sound data is read from the nonvolatile storage module 110A. FIG. 19 shows a bit format of the music sound data that is read from the nonvolatile storage module 110A onto the external bus. As indicated by this bit format, the music sound data includes two different sets of data: one obtained with the weakest touch and the other with the strongest touch. The CPU 230A transfers the music sound data to the buffer 231_0 included in the music sound data buffer 231, and temporarily stores the music sound data into an area of the dual port RAM 231_0a corresponding to the channel CH0 via the multiplexer 231_0c (M=0) shown in FIG. 5. When the music sound data is stored temporarily, the selection from the buffers 231_0 to 231_3 or the selection from the storage areas of the dual port RAMs included in each buffer are determined by the channel number CHN entered in the MM register 242 (described later).

All samples of the first sector, or specifically the two sets of 512-byte data from s0 to S127 obtained with the weakest touch and with the strongest touch are temporarily stored into the area of the dual port RAM 231_0a corresponding to the channel CH0. Subsequently, the transfer monitoring unit 235 included in the CPU 230A transfers the transfer completion flag TRNF to the signal processing unit 220. The processing in step S130 and subsequent steps performed by the CPU 230A and the music sound data transfer (including the monitoring of the transfer) to the music sound data buffer 231 are performed in parallel.

After the processing in step S130, the CPU 230A controls the signal processing unit 220 to generate sound (S131). In the sound generation control, the CPU 230A calculates the level data LD by an operation written as TP/0x7F, and sets the calculated level data LD into the LD field of the channel assign table 232. The CPU 230A sets the flag KON extracted in step S125 into the KON field of the channel assign table 232. In the above operation, 0x7F indicates the maximum value of the touch parameter TP. In this case, the value of the level data LD is within a range of 0 to 1 inclusive in accordance with the touch parameter TP. The operation of the signal processing unit 220 will be described later.

When detecting no unoccupied channel in step S127, that is, when the flag SON is all set at 1 in the channel assign table 232, the CPU 230A sets the compulsory sound elimination flag F included in the channel assign table 232 to 1 (S128), and advances to step S132.

Subsequently, the CPU 230A determines whether the play data buffer stores music sound data that is to be processed next (S132). When the play data buffer stores music sound data that is to be processed next, the processing returns to step S121. In step S121, the previous play data has been already processed completely. Thus, the processing unconditionally advances to S122 and subsequent steps. When the play data buffer stores no music sound data to be processed next in step S132, the interrupt routine is terminated. In this case, the processing returns to the main routine, and the CPU 230A resumes the processing that was being executed when shifting to the interrupt routine.

### Operation of Signal Processing Unit 220

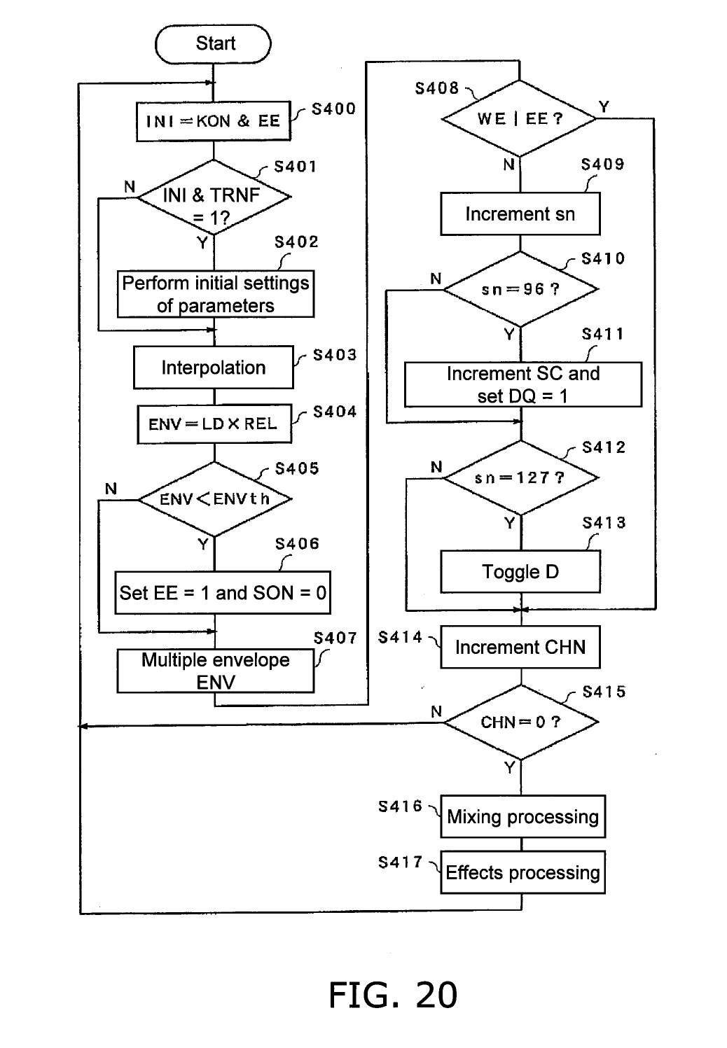

The operation of the signal processing unit 220 will now be described using mainly the flowchart shown in FIG. 20.

In step S400, the initial flag INI is set as written in expression (12).

INI=KON & EE Expression (12)

In expression (11), the flag EE is an element used to calculate the flag INI. This is due to the reason described below. When a key is struck newly while all the channels are currently being used to generate sound (the flag EE is set to 0), sound generation corresponding to the newly struck key needs to wait until the sound generated using the channel corresponding to the newly struck key is eliminated rapidly, or until the flag EE is set to 1 and the flag SON is set to 0 for the channel. This prevents noise from being generated.

To shorten the delay time taken from when the key is struck newly to when the sound generation is started, the channel assigning process corresponding to the newly struck key (S129) and the music sound data reading process (S130) need to be performed simultaneously as when the rapid sound elimination is instructed to be performed. However, when the flag KON of the channel to which at least the newly struck key is assigned is set at 1 immediately before the key is struck newly, the channel corresponding to the newly struck key is controlled to perform new sound generation following the rapid sound elimination, without setting the flag KON to 0 or in other words while maintaining the flag KON to be 1. In this case, the flag KON cannot be used as an element that determines the timing at which the sound generation is to be started. For this reason, the flag EE is used as an element to calculate the flag INI in expression (12). The application of expression (12) should not be limited to the above-described operation, but expression (12) is applicable to any case.

In step S401, the signal processing unit 220 performs determination associated with the flags INI and TRNF. When the transfer completion flag TRNF is transferred from the CPU 230A into the RAM of the signal processing unit 220, the flags INI and TRNF are both set to 1. In this case, the processing advances to step S402, in which the initial settings of the parameters are performed. In the initial settings of the parameters, the sector number sn stored in the counter included in the signal processing unit 220 is set to 0, and the transfer completion flag TRNF stored in the RAM of the signal processing unit 220 is set to 0.

After the processing in step S401 or S402 is performed, the signal processing unit 220 performs interpolation (S403). The interpolation is the processing for changing the pitch of the music sound in accordance with the strength of the key stroke, that is, the value of the touch parameter TP. The pitch of the music sound generated when the key is struck strongly typically has more high frequency elements than the pitch of the music sound generated when the key is struck weakly. In the present embodiment, music sound data obtained with the strongest touch, which represents the pitch of the music sound generated when the key is struck strongly, and music sound obtained with the weakest touch, which represents the pitch of the music sound generated when the key is struck weakly, are used for two-point linear interpolation based on the touch parameter TP. This enables the pitch of the data to change in accordance with the touch parameter TP. More specifically, the interpolation is performed in accordance with expression (13). In the expression, w is the value of a single sample of music sound data that has been subjected to the interpolation, wa is the value of a single sample of music sound data corresponding to the weakest touch, wb is the value of a single sample of music sound data corresponding to the strongest touch, and α is an interpolation coefficient having a value of 0 to 1.

w=wb*α+wa*(1−α) Expression (13)

where α=TP/0x7F.

After the interpolation, an envelope (hereafter referred to as “ENV”) is calculated using expression (14) (S404).

ENV=LD*REL Expression (14)

where REL is determined as follows:

(a) REL=g when F=1.

(b) REL=REL old*0.5 when F=0, KON=0, and PD=0.

(c) REL=1 in any other case.

In the above expressions, REL is an attenuation parameter, REL_old is the REL used in the previous sampling period, and g is an attenuation variable.

The variable g is a time varying parameter having a value of 0.875 in the sampling cycle in which F=1 is transferred from the CPU 230A, and having a value of 0.750 in the next sampling period. Thereafter, the value of the variable g decreases in units of 0.125, and then reaches 0 and is then maintained at 0. Under these settings, the value of the envelope ENV reaches 0 when eight samples of data are obtained after F=1 is transferred. The REL_old is stored in the RAM included in the signal processing unit 220, and is updated to the REL every time when the calculation written as expression (14) is performed. The REL then asymptotically approaches zero in an exponential manner.

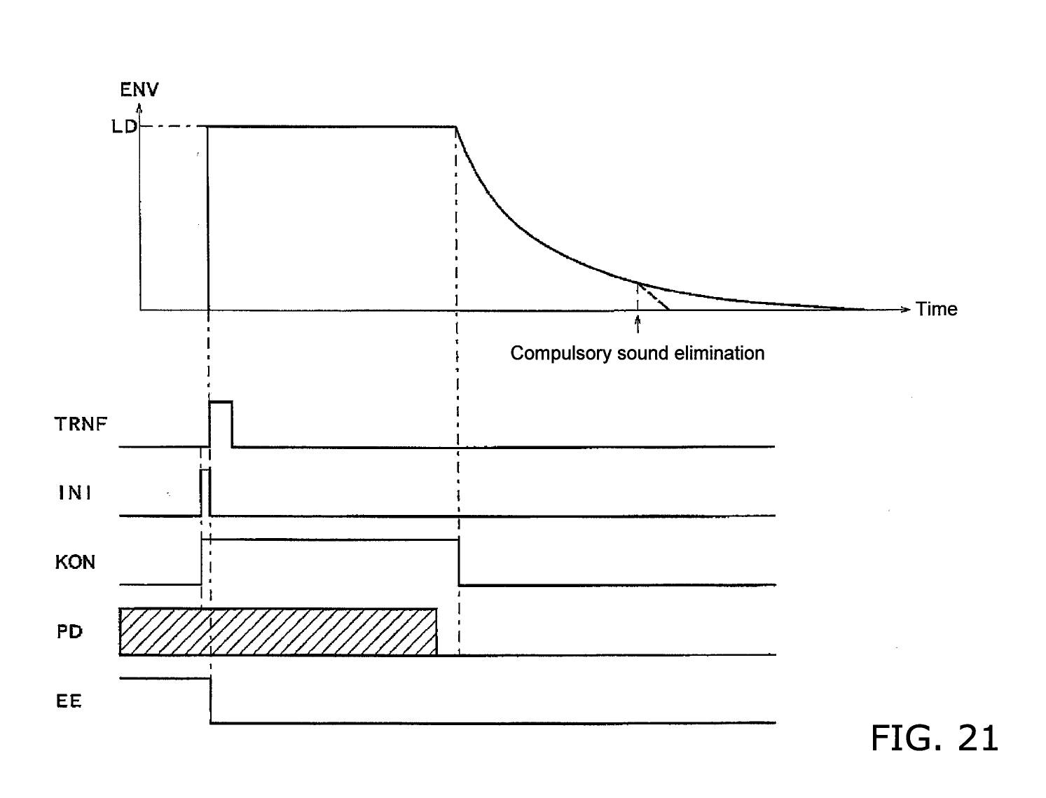

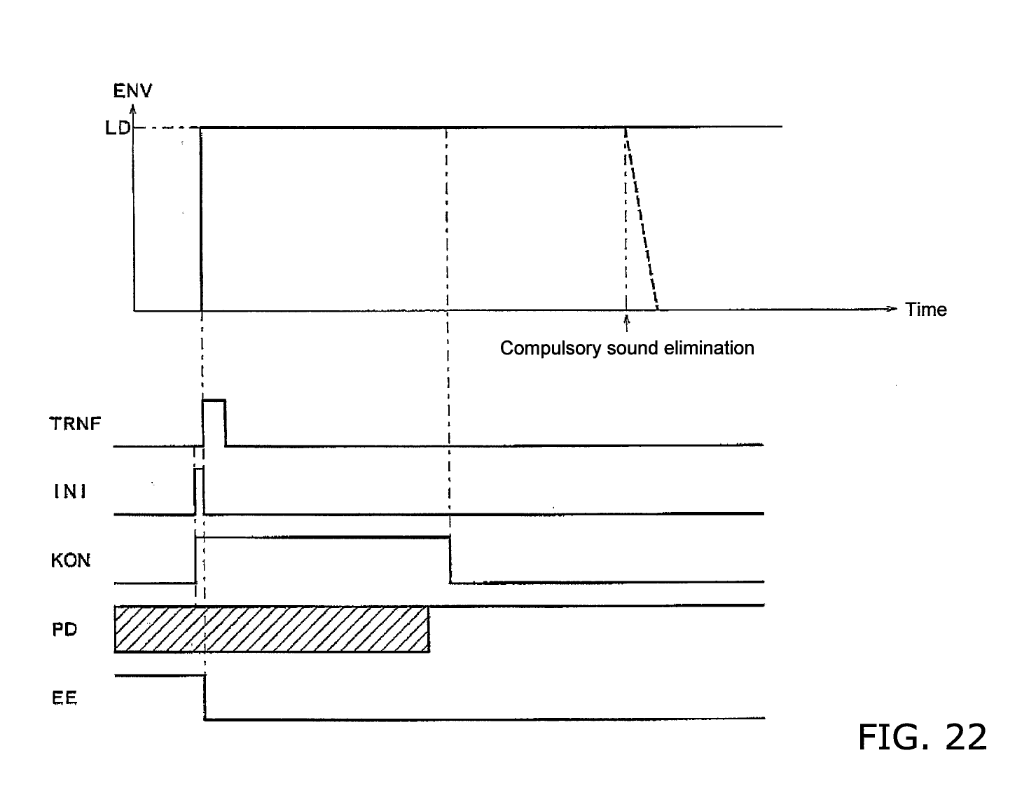

FIGS. 21 and 22 show temporal changes in the envelope ENV. FIG. 21 shows changes in the envelope ENV when the flag PD is set at 0, that is, when the sustaining pedal is off. In this case, the envelope ENV remains unchanged as in the state (c) described above while the flag KON is at 1. The envelope ENV starts attenuating in an exponential manner when the flag KON is set to 0, that is, when the key is released. FIG. 22 shows changes in the envelope ENV when the flag PD is set at 1, that is, when the sustaining pedal is on. In this case, the envelope ENV remains unchanged as in the state (c) described above even after the flag KON is set to 1. In other words, the envelope ENV maintains its value set when the key is struck. In both FIGS. 21 and 22, the envelope ENV enters the state (a) described above when compulsory sound elimination is instructed to be performed, that is, when the flag F is set to 1. The parameter REL used in the state (a) is the time varying parameter g. During the eight sampling periods indicated by a broken line, the envelope ENV attenuates linearly and reaches 0. The single sampling cycle is written as expression (15).

1/sampling frequency (44.1 kHz)≈22.7 microseconds Expression (15)

The eight sampling periods correspond to about 182 microseconds.

The envelope ENV is calculated, and is compared with the threshold ENVth (S405). The threshold ENVth is a value at which the sound is too small to be perceived by the human ear. When the envelope ENV is below the threshold ENVth in step S405, the flag EE is set to 1 for the corresponding channel included in the channel assign table 232 of the CPU 230A, and the flag SON is set to 0 (S406). The channel for which the flag SON is updated to 0 is thereafter managed as an unoccupied channel.

The digital data W is calculated using expression (16) after the envelop processing is performed (S407).

W=w*ENV Expression (16)

As described above, the music sound data is data obtained by digitally recording sound of the piano corresponding to each key of the piano. In this case, the wave height value of the data W attenuates with time although the level of the envelope ENV does not change with time. As a result, the human ear perceives the sound as if the sound attenuates with time.

Subsequently, when the flag WE is set to 1, indicating that the music sound data corresponding to a selected key stroke is the last sample (sample s1763999), or when the flag EE is set to 1, indicating that the envelope ENV reaches a level that cannot be perceived by the human ear (S408), the output for the signal processing is no longer necessary. This eliminates the need for incrementing the sector number sn and performing the toggle operation of the selection flag D. The processing jumps to S414. In any other case, the processing advances to S409, in which the sector number sn is incremented. The wave end flag WE is recorded at bit b0 of the music sound data obtained from the music sound data buffer 231 as shown in FIG. 10. The wave end flag WE is set at 1 only for sample s1763999. The flag WE is maintained at 1 for the corresponding channel WE until the music sound data whose bit b0 is 0 is read in step S403.

When the sector number sn is 96 in step S410, the processing advances to step S411. To read one sector of the next music sound data, the sector counter SC of the corresponding channel included in the channel assign table 232 is incremented, and the corresponding read request flag DQ for music sound data is set to 1. When the sector number sn is a value other than 96, the processing advances to S412 without performing this processing.

In step S412, the signal processing unit 220 determines whether the sector number sn reaches 127, or in other words the currently processed sample is the last sample of the single sector of music sound data. When the sector number sn reaches 127, the signal processing unit 220 toggles the selection flag D, or more specifically, logically inverts the value of the selection flag D. This operation is performed by, for example, switching the selection flag D of the corresponding channel included in the channel assign table 232 from 0 to 1, and switching the input of the demultiplexer included in the music sound data buffer 231, which is for example the buffer 231_0d. As a result, the RAM from which the music sound data is read is switched from the dual port RAM 231_0a to the dual port RAM 231_0b.

Subsequently, the signal processing unit 220 increments its internal channel number CHN. When the channel number CHN is not 0, the processing returns to S401 to perform the processing for the next channel. The channel number CHN is stored into a 5-bit counter, and is cyclically updated among CH0 to CH31. When the channel number CHN is 0 in S415, that is, when the processing for up to the channel CH31 is completed, the processing shifts to mixing processing (S416).

In the mixing processing, data Wn of the channels CH0 to CH31 is subjected to mixing as written in (17).

Wx=(W0+W1+ . . . +W31)/32 Expression (17)

In this expression, Wn (n is an integer of the corresponding CHN, or 0 to 31) is W of a selected channel, and Wx is data resulting from the mixing. After the mixing processing, the effects processing is further performed in step S417.

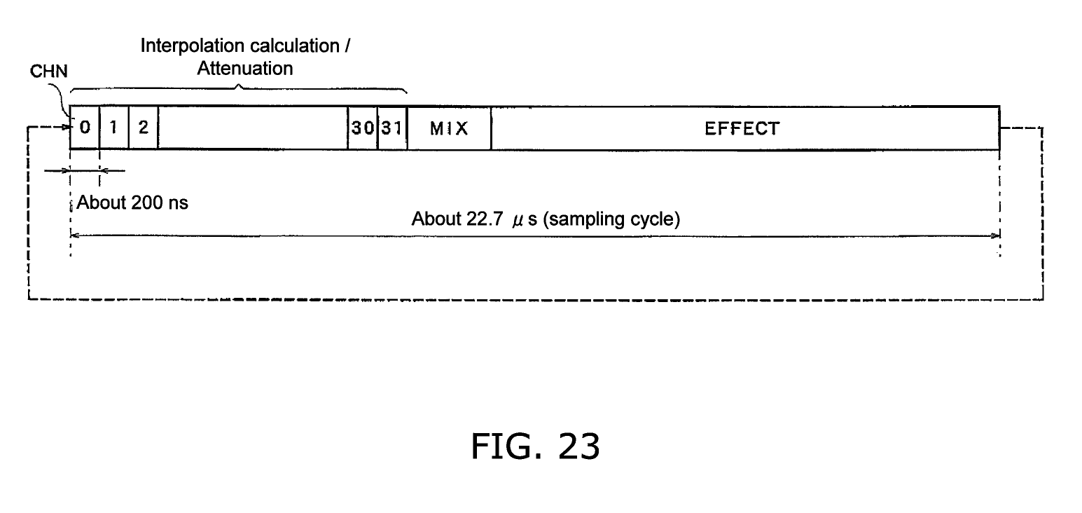

FIG. 23 shows time slots for the signal processing per sampling cycle. In FIG. 23, the time slots on the left indicate earlier times. After the data corresponding to the channels CH0 to CH31 is subjected to the interpolation and the level control, the data for the channels CH0 to CH31 is further subjected to the mixing processing of music sound (MIX), and then to the effects processing (EFFECT) including reverb and chorus. The sequential processing is performed cyclically in every sampling cycle of 22.7 microseconds.

The signal processing described above is repeatedly performed in every single sampling cycle (22.7 microseconds). The resulting music sound data is converted through digital to analogue conversion performed by the DA converter included in the input/output unit 210A in every 22.7 microseconds. The resulting data is then output, as desired music sound, to an external unit via the line out terminal. The music sound is then output as the play sound of the piano via an external amplifier and an external speaker.

Referring back to FIG. 13A showing the main routine of the CPU 230A, the processing in step S102 and subsequent steps will now be described. The CPU 230A checks the flag F for all channels included in the channel assign table 232 in step S102. When detecting a channel for which the flag EE is set at 1 among channels for which the flag F is set at 1, the CPU 203A clears the value of the flag F for the detected channel to 0 (S103), and performs the channel assigning process of the channel (S104). As described above, the signal processing unit 220 clears the flag EE in step S402.

Subsequently, the music sound data is read (S105), and the sound generation control over the signal processing unit 220 is executed (S106). The processing in steps S105 and S106 is identical to the processing in steps S130 and S131 described above.

In step S107, the CPU 230A searches the channel assign table 232 for a channel for which the flag DQ is set at 1. When detecting such a channel, the CPU 230A transmits a read request for reading music sound data corresponding to the detected channel in step S108. The searching the channel assign table 232 in steps S107 and S102 is performed in ascending order of channels from the channel CH0.

### (2) Sound Generation Delay Time

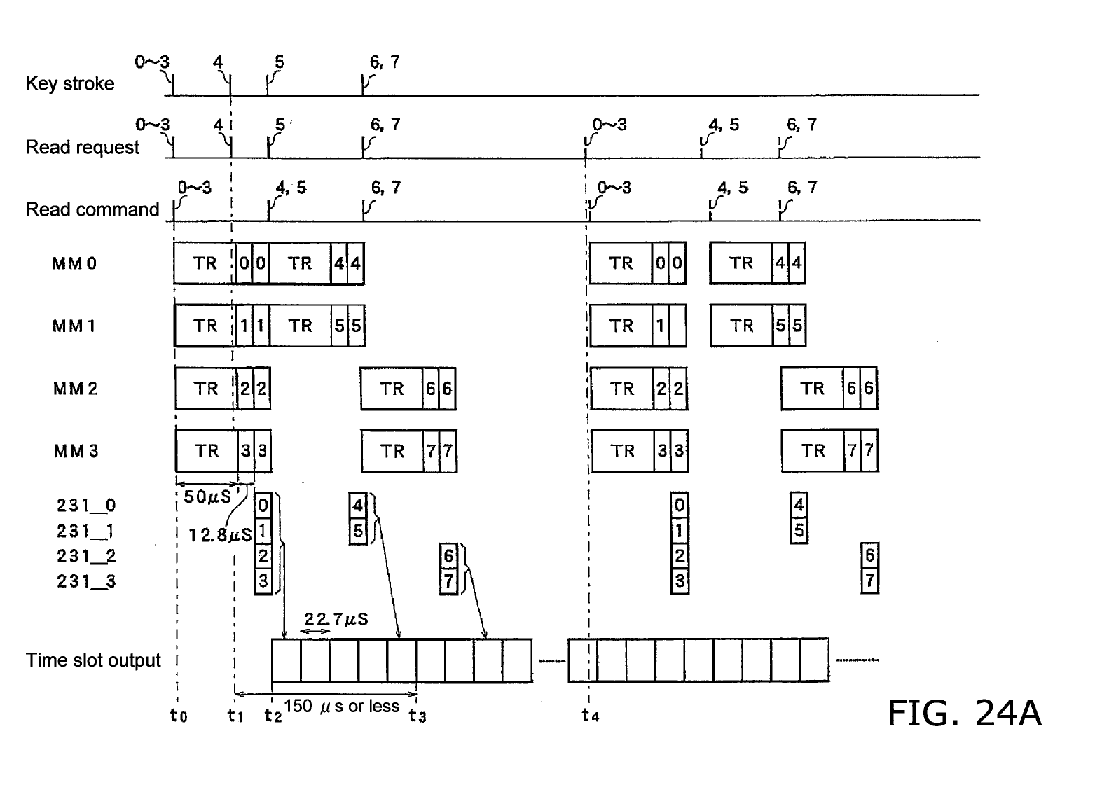

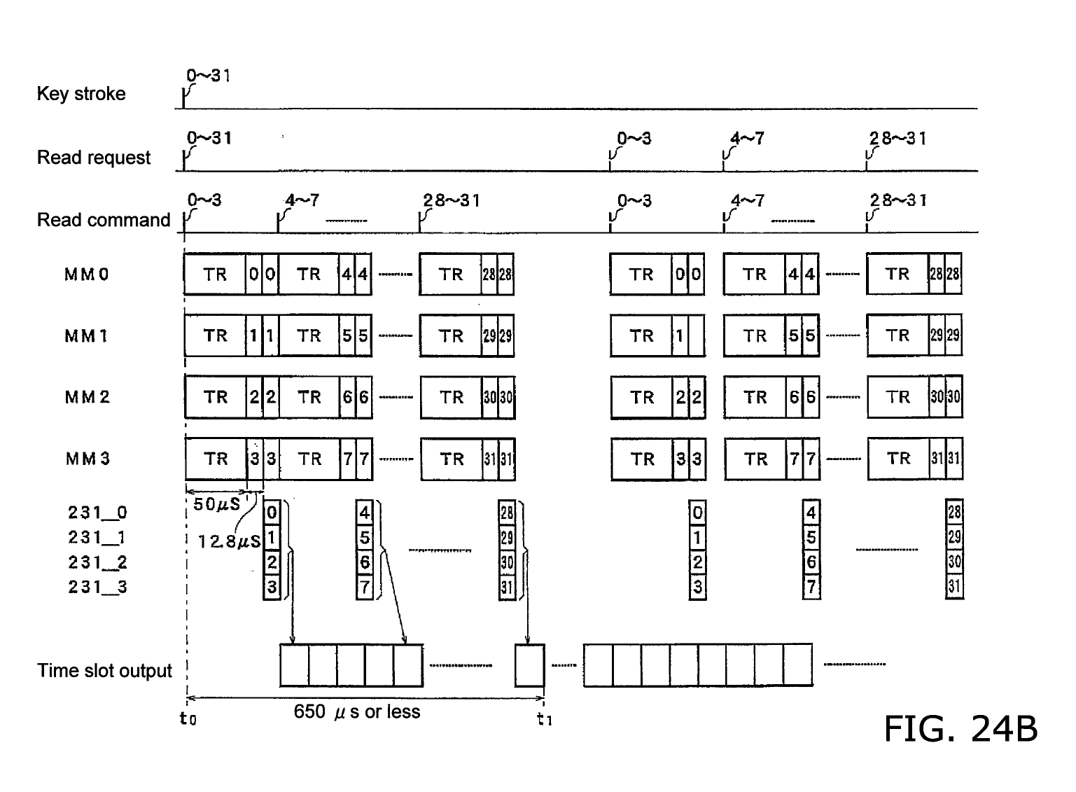

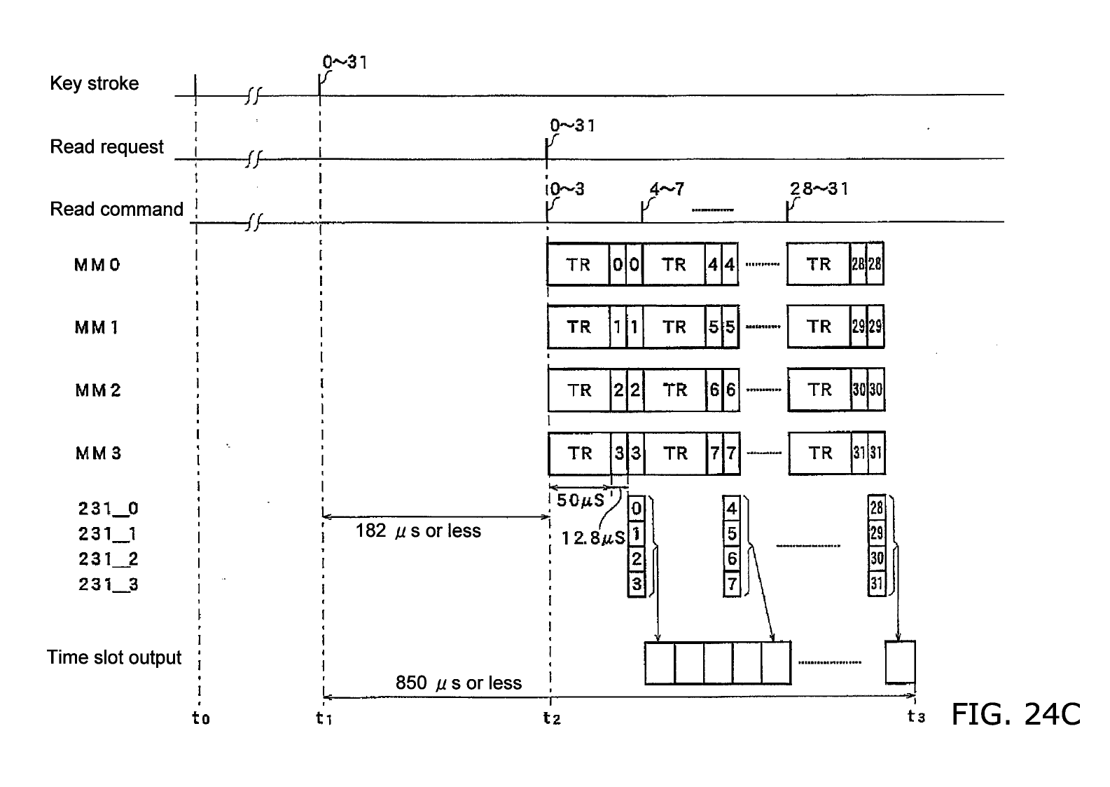

Based on the processing described above, the operation performed before music sound is generated after a key is struck and the sound generation delay time will now be described with reference to the timing charts shown in FIGS. 24A to 24C and the channel assign table 232 shown in FIGS. 6A to 6C. The operation will be described in accordance with different key striking situations.

### (2-1) When Keys are Struck Dispersedly

FIG. 24A is a timing chart describing the operation performed when keys are struck dispersedly. FIG. 6A shows changes in the parameters included in the channel assign table 232 corresponding to this stroke operation of the keys.

While no sound is being generated, four keys corresponding to the note number NN of 0x19, 0x1C, 0x1E, and 0x20 are struck simultaneously at timing t0 using the master keyboard 300. Subsequently, a key corresponding to the note number NN of 0x25, a key corresponding to the note number NN of ox29, and two keys corresponding to the note number NN of 0x2C and 0x2F are struck at time intervals of several tens microseconds. The operation performed in this case will now be described. These key strokes are assigned to CH0 to CH7 through the channel assigning process described above performed by the CPU 230A. A read request corresponding to each of the channels CH0 to CH7 is then output to the read command unit 240 at a timing obtained by adding the processing delay of the CPU 230A to the timing at which each key is struck. Further, the read command unit 240 transfers the read-command information to the storage module 100A in accordance with the access status of the nonvolatile storage module group as described above.

While music sound data is being read from the nonvolatile memory bank to the memory controller and while the data is being transferred from the memory controller to the access module 200A, the access module 200A is disabled to transfer the next read-command information. Thus, the read-command information is transferred to the storage module 100A at the timings shown in FIG. 24A, at which a read command for each of the channels CH0 to CH7 is transferred from the access module 200A to the storage module 100A. In accordance with the transfer timings, music sound data is read from the memory cell array included in the memory banks 112 to 142 into the I/O register during the read time TR.

Subsequently, the music sound data is read from the I/O register into the memory controller during the transfer time TT1. The music sound data is then temporarily stored into the music sound data buffer 231 from the memory controller via the read command unit 240 during the transfer time TT2.

In the manner described above, the signal processing unit 220 generates music sound using the music sound data stored in the music sound data buffer 231. The signal processing unit 220 performs the processing corresponding to the channels CH0 to CH31 in every single sampling cycle in a time sharing manner. More specifically, the signal processing unit 220 uses the music sound data corresponding to each channel in every 22.7 microseconds sequentially in the order of samples from the first sample s0.

For the channels CH0 to CH3, the sample s0 is used in the first time slot that starts from the timing t2 shown in FIG. 24A. After a delay of four time slots from this time slot, the use of the sample s0 for the channels CH4 and CH5 is started. After a further delay of three time slots from this time slot, the use of the sample s0 for the channels CH6 and CH7 is then started.

In each channel, all music sound data of 512 bytes is used up in the 127^{th} time slot from the first time slot in which the sample s0 is used. In this case, as described above, the next music sound data of 512 bytes needs to be obtained in advance at timing t4 at which the sector number sn reaches 96. The timing at which the next music sound data of 512 bytes is obtained should not be limited to the timing when the sector number sn reaches 96, but may be any timing specified by another value. It is only required that the next music sound data of 512 bytes be obtained before the timing at which the music sound data is to be processed.

At the timings indicated by a broken line in FIG. 24A, a read command for the channels CH0 to CH7 is transferred from the access module 200A to the storage module 100A. The read command is transferred at time intervals of time slots, that is, at time intervals of 22.7 microseconds.

The sound generation delay time will now be described.

The sound generation delay time refers to the time required from when a key is struck to when sound corresponding to the sample s0 for the struck key is generated. In the example of FIG. 24A, the sound generation delay time for CH4 is the longest during a period from timings t1 to t3. The sound generation delay time for CH4 is 150 microseconds or less during this period. This sound generation delay time is sufficiently shorter than 1 millisecond, which is a permissible range of the sound generation delay time. In the example shown in FIG. 24A, the music sound generation system of the present embodiment is acceptable as a music sound generation system for an electronic instrument.

### (2-2) When Keys are Struck in a Concentrated Manner

The operation performed when sound is generated using all the 32 channels at a time will now be described.

FIG. 24B is a timing chart showing the operation performed when 32 keys are struck altogether at timing t0 using the master keyboard 300. FIG. 6B shows changes in the parameters included in the channel assign table 232 corresponding to the stroke operation of the keys. This key stroke operation is not common for normal play of the instrument.

In this case, 32 keys corresponding to the note number NN of 0x28 to 0x47 are struck simultaneously as shown in FIG. 6B. These key strokes are assigned to CH0 to CH31 through the channel assigning process described above performed by the CPU 230A. A read request corresponding to each of the channels CH0 to CH31 is then output to the read command unit 240 at a timing obtained by adding the processing delay of the CPU 230A to the timing at which each key is struck. Further, the read-command information corresponding to the read request is transferred from the access module 200A to the storage module 100A. Thereafter, music sound data is transferred to the music sound data buffer 231, and music sound is generated based on the music sound data as shown in FIG. 24B.

In this case, the sound generation delay time becomes the longest for the channels CH28 to CH31 during a period from timings t0 to t1. The sound generation delay time for CH28 to CH31 is 650 microseconds or less during this period as shown in FIG. 24B. This sound generation time is shorter than 1 millisecond, which is a permissible range of the sound generation delay time. In the example shown in FIG. 24B, the music sound generation system of the present embodiment is acceptable as a music sound generation system for an electronic instrument.

### (2-3) When Keys are Struck in a Concentrated Manner After Rapid Sound Elimination is Performed

Finally, the operation performed when all the 32 channels are used at a time to generate sound after rapid sound elimination will be described with reference to FIG. 24C and FIG. 6C. While 32 keys corresponding to the note number NN of 0x28 to 0x47 are being struck at timing t0 in the manner described in (2-2), or as shown in FIG. 6C, 32 keys corresponding to the note number NN of 0x48 to 0x67 are newly struck at timing t1. In this case, the number of channels required to generate sound exceeds the maximum number of channels (32 channels).

The sound generation control exceeding the maximum number of channels is executed in the manner described below. The 32 channels that have already been used to generate sound are subjected to rapid sound elimination in advance, or in other words, the sound generated using the 32 channels is eliminated rapidly in advance. As a result, the flag EE is set to 1 for the 32 channels. After the sound generated using the 32 channels is reduced to a level at which the sound is not perceived by the human ear, new key strokes are assigned to the 32 channels. This operation causes the longest sound generation delay time.

The rapid sound elimination is performed for a period of 182 microseconds corresponding to eight sampling cycles immediately after the keys are struck at timing t1 in FIG. 24C. In FIG. 6C, all the channels are newly processed as channels for which the key stroke operation is performed, without requiring the corresponding struck keys to released and while these channels are being used to generate sound. In this case, the flags KON and SON are both at 1 for these channels when these channels are newly processed as the channels for which the key stroke operation is performed. After the rapid sound elimination performed by the signal processing unit 220, the flag EE is set to 1 and the flag SON is set to 0. As a result, the read-command information for the channels CH0 to CH31 is transferred to the storage module 100A through the channel assigning process performed by the CPU 230A. The subsequent processing shown in the timing chart is the same as the processing shown in the timing chart of FIG. 24B.

In this case, the sound generation delay time becomes the longest for the channels CH28 to CH31 during a period from timings t1 to t3. The sound generation delay time is 850 microseconds or less for CH28 to CH31 during this period as shown in FIG. 24C. This sound generation time is shorter than 1 millisecond, which is a permissible range of the sound generation delay time. The music sound generation system of the present embodiment is thus acceptable as a music sound generation system for an electronic instrument.

In the music sound generation system of the first embodiment described above, music sound data is recorded in each of the nonvolatile memory banks 112 to 142, or in other word, music sound data is recorded in a multiplex manner. This enables the read command unit 240 to read music sound from a plurality of nonvolatile memory banks in parallel in accordance with a read command transmitted from the access module 200A. The music sound generation system of the present embodiment can thus be used as a system that cannot predict the pitch of music sound data for which a read command is transmitted, such as a system for generating music sound. More specifically, the music sound generation system of the present embodiment enables a plurality of pieces of data to be read from a plurality of nonvolatile memory banks in parallel. This shortens the sound generation delay time to less than 1 millisecond, which is a permissible range of the sound generation delay time. The above processing of the music sound generation system enables a music sound signal generation apparatus to be formed at a low cost as well as with a small size using, as a memory for music sound data, a large-capacity flash memory, which is currently a major flash memory.

### Second Embodiment

A second embodiment of the present invention will now be described.

### 2.1 Structure of Music Sound Generation System.

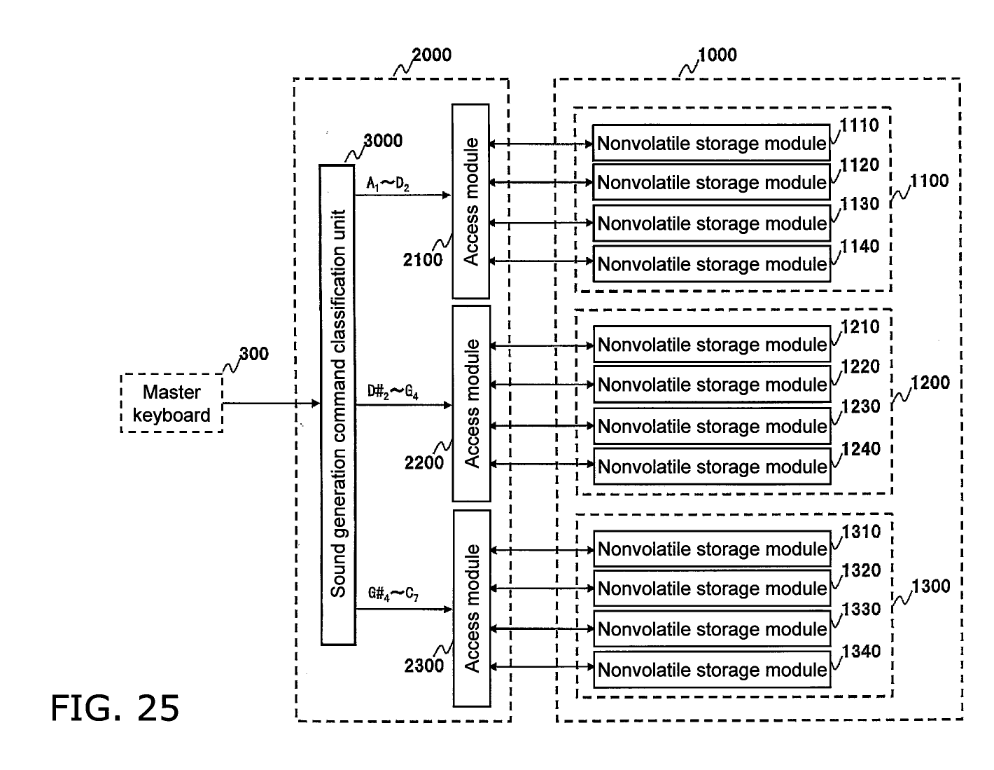

FIG. 25 is a block diagram of a music sound generation system according to a second embodiment of the present invention. The music sound generation system of the present embodiment includes a storage module group 1000 and an access module 2000. The storage module group 1000 includes storage modules 1100 to 1300. The access module 2000 includes a sound generation command classification unit 3000 and access modules 2100 to 2300.

The storage modules 1100 to 1300 are basically identical to the storage module 100A described in the first embodiment. The difference between them lies in that the storage modules 1100 to 1300 store all pitches (the lowest pitch to the highest pitch) of the piano sound as being divided in the different storage modules although the storage module 100A alone stores all the pitches.

The access modules 2100 to 2300 are basically identical to the access module 200A described in the first embodiment. The difference between them lies in that the access modules 2100 to 2300 process sound generation commands corresponding to all pitches (the lowest pitch to the highest pitch) of the piano sound as being divided for the different access modules although the access module 200A alone processes sound generation commands corresponding to all the pitches. The sound generation command corresponds to the key stroke data (FIG. 16) described in the first embodiment. The pedal data is transferred commonly to the access modules 2100 to 2300.

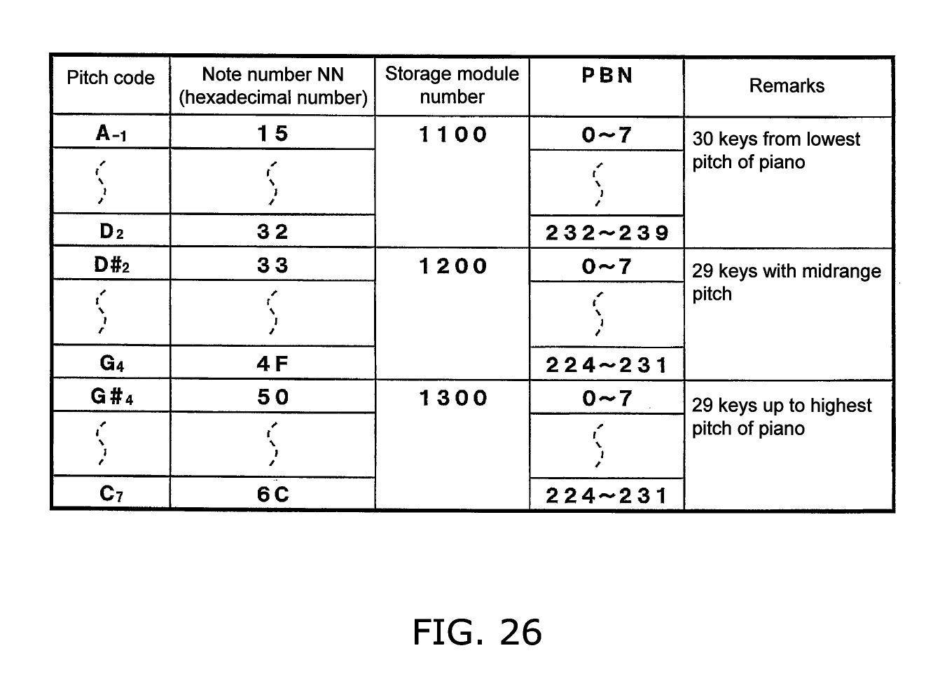

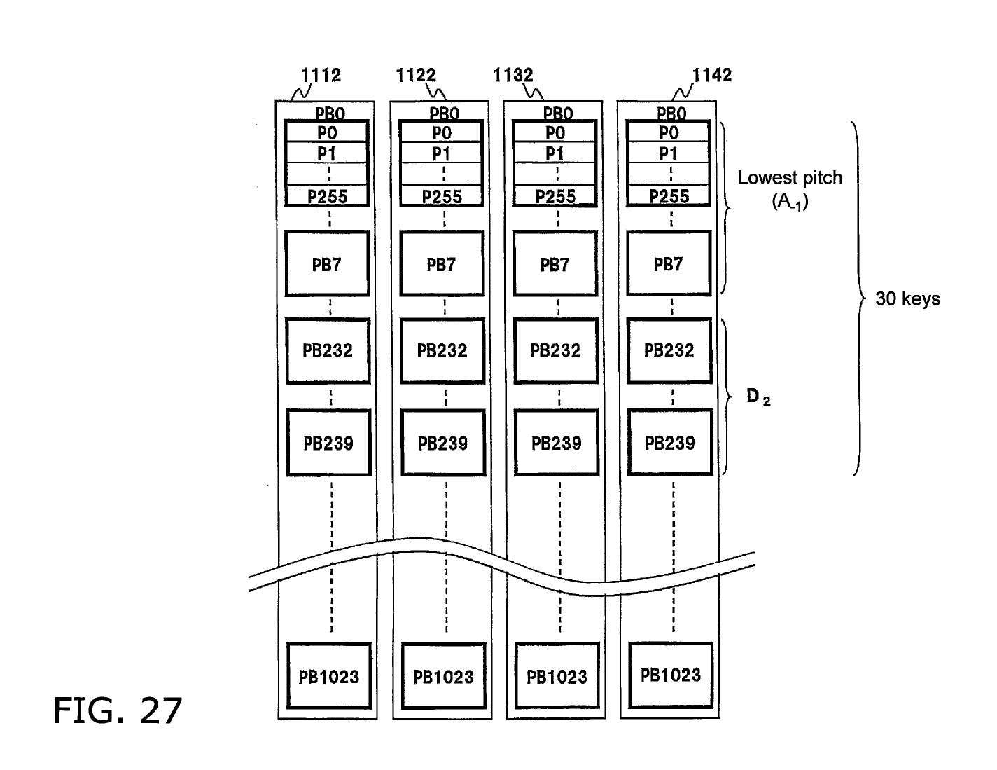

FIG. 26 is a table showing the correspondence between the pitch code and music sound data that is stored as being divided in the storage modules 1100 to 1300. FIG. 27 shows a memory map representing the recording state of the storage module 1100.

### 2.2 Operation of Music Sound System

The operation of the music sound generation system of the present embodiment with the above-described structure will now be described.

A sound generation command transferred from the master keyboard 300 is classified by the sound generation command classification unit 3000. A sound generation command in a command group A-1 to D2 is transferred to the access module 2100, a sound generation command in a command group D#2 to G4 is transferred to the access module 2200, and a sound generation command in a command group G#4 to C7 is transferred to the access module 2300. The sound generation command groups are subjected to the same processing as described for the access module 200A in the first embodiment, and are output, as read commands, to the storage module group 1000. The group A-1 to D2 is referred to as a pitch group 0, the group D#2 to G4 is referred to as a pitch group 1, and the group G#4 to C7 is referred to as a pitch group 2. It is preferable that these pitch groups do not include the same pitch, or in other words, that these pitch groups are exclusive. However, the pitch groups may include the same pitch although the same pitch in different groups is redundant. When the pitch groups include the same pitch, a sound generation command for the same pitch of different groups may be generated preferentially for the pitch group with a smaller group number.

The access module 2100 performs the processing for sound generation commands associated with 30 keys at a maximum. The number of channels to be processed by the access module 2100 is 30 or less. In this case, the access module 2100 reads music sound data from the storage module 1100 and generates desired music sound based on a timing chart corresponding to either FIG. 24A or FIG. 24B. The same applies to the access modules 2200 and 2300. The access module performs the processing in a manner that the sound generation delay time will be within 1 millisecond. Although the compulsory sound elimination shown in FIG. 24C needs to be performed when sound generation commands are generated for 32 or more channels in the first embodiment, the access module 2100 processes 30 keys at a maximum and the access modules 2200 and 2300 each process 29 keys at a maximum in the second embodiment, or in other words these access modules are only required to perform the processing for less than 32 channels. This eliminates the need for the compulsory sound elimination, and improves the sound quality.

The classification of sound generation commands performed by the sound command classification unit 3000 will now be additionally described. Although the 88 keys included in the master keyboard 300 are divided into three groups in the second embodiment, the keys may be divided into 11 groups each including 8 keys. Although this structure requires 11 pairs of access modules and storage modules and increases the circuit scale, each pair of an access module and a storage module is only required to process eight channels. According to the timing charts of FIGS. 24A and 24B, the use of only a single nonvolatile storage module satisfies the sound generation delay time of 1 millisecond. This streamlines the storage capacity of the music sound data.

In the music sound generation system of the present embodiment described above, the sound generation command classification unit 3000 classifies (groups) sound generation commands according to the pitch. When one group includes more than 8 channels, music sound data is recorded in a multiplex manner in a plurality of nonvolatile storage modules included in the storage module. The read command unit included in the access module then reads the music sound data from the plurality of nonvolatile storage modules in parallel. This structure reduces the sound generation delay time to fall within a range of 1 millisecond. Further, the music sound generation system of the present embodiment reduces the sound generation delay time to fall within a range of 1 millisecond while allowing the storage module to include only the single nonvolatile storage module, or in other words while eliminating the need to record the music sound data in a multiplex manner when the number of channels included in one group is 8 or less.

### Other Embodiments

In the first and second embodiments, data obtained by digitally recording the sound of the piano is recorded into the nonvolatile memory banks 112 to 142 and 1112 to 1142 as music sound data. However, the present invention should not be limited to this structure. For example, sound of an instrument other than the piano or other sound, or other data may be stored in the nonvolatile memory banks Further, the music sound data may not be the digitally recorded data, but may be artificially created data. The data may be compressed with a compression technique, such as MP3. In that case, the signal processing unit 220 is required to decompress or decode the compressed data. Although two types of music sound data corresponding to the different key touch strengths are prestored in the above embodiments, only one type of music sound data or three or more types of music sound data may be used. When one type of music sound data is used, the interpolation performed by the signal processing unit 220 is eliminated. When three or more types of music sound data are used, the interpolation is to be performed using three-point linear interpolation or the like. Alternatively, filtering may be performed instead of the interpolation.

Although the music sound data corresponding to a single key is data of about 40 seconds in the present embodiment, the present invention should not be limited to this structure. The time length of the music sound data may be changed in accordance with the note number NN. For the piano, the time for which sound is being generated is usually longer as the pitch of the sound is lower. It is preferable that the time length of the music sound data is set relatively longer for lower pitches, and the time length of the music sound data is set relatively shorter for higher pitches. This streamlines the storage capacity. Further, the same music sound data is recorded in a multiplex manner in the nonvolatile memory banks 112 to 142 and 1112 to 1142 in the above embodiments. However, the music sound data stored in each of the nonvolatile memory banks 112 to 142 or the nonvolatile memory banks 1112 to 1142 may have slightly different values when the sound generated based on the music sound data stored in each memory bank is perceived as substantially the same sound by the human ear.

The storage module 100A and the storage module group 1000 each may be formed as a removable storage device, such as a memory card, or may be formed as a memory unit that is incorporated in an apparatus such as an electronic instrument. Each of the storage modules 1100 to 1300, the nonvolatile storage modules 110A to 140A, and the nonvolatile storage modules 1110 to 1340 may be formed as a removable storage device, such as a memory card. Each of the access modules 150 and 2000 may be an apparatus including an electronic instrument, or may be an access circuit that is incorporated in an electronic instrument.

Although the system of the first embodiment includes four nonvolatile storage modules, the present invention should not be limited to this structure. When including more nonvolatile storage modules, the system can shorten the sound generation delay time more. Although the sector size, or the reading size of the music sound data per access is 512 bytes, the sector size may be another size. When the sector size is smaller, the capacity of the RAM included in the music sound data buffer is streamlined more. However, when the sector size is too small, the music sound generation process is disabled. Further, the single nonvolatile storage module may include a plurality of nonvolatile memory banks Although the first embodiment describes the case in which the nonvolatile storage module to which read-command information is to be transferred is determined through the processing in steps S202 to S208 in FIG. 14A in accordance with the assigning status associated with the nonvolatile storage module group, the correspondence between the CHN and the MMN may be fixed as (a) to (d) below.

(a) CH0, CH4, CH8, CH12, CH16, CH20, CH24, and CH28 correspond to MM0 (nonvolatile storage modules 110A and 110B)

(b) CH1, CH5, CH9, CH13, CH17, CH21, CH25, and CH29 correspond to MM1 (nonvolatile storage modules 120A and 120B)

(c) CH2, CH6, CH10, CH14, CH18, CH22, CH26, and CH30 correspond to MM2 (nonvolatile storage modules 130A and 130B)

(d) CH3, CH7, CH11, CH15, CH19, CH23, CH27, and CH31 correspond to MM3 (nonvolatile storage modules 140A and 140B)

Although the music sound data is arranged continuously in a page in the above embodiments, the music sound data may be arranged discontinuously when the storage module 100A and the access module 200A can determine the regularity of such arrangement. Although the music sound data is arranged sequentially in the order of pitches from the lowest pitch using the block PB0 as the first block in the first embodiment, the music sound data may be arranged using a block other than the block PB0 as the first block or may be arranged discontinuously when the storage module 100A and the access module 200A can determine the regularity of such arrangement.

Although the above embodiments describe the case in which the nonvolatile memory bank is used as a flash memory, the present invention is applicable to cases in which other nonvolatile memories are used.

Although the above embodiments describe the case in which the property information of the music sound data and the memory structure information are stored into the nonvolatile memory bank, another nonvolatile memory may be used to store the property information of the music sound data and the memory structure information. Alternatively, the memory structure information may be processed as information standardized in advance.

The memory controllers 111A to 141A may be included in the access module 200A. In this case, each of the nonvolatile memory banks 112 to 142 may be packaged into a single memory chip, or two or more of the nonvolatile memory banks 112 to 142 may be packaged into a single memory pack.

Although the play information is input using the master keyboard 300 in the above embodiments, the input controller may be of another type, such as a guitar controller that outputs play data when its string is plucked, a stick controller that outputs play data when an object is beaten with a stick, or a controller that includes an acceleration sensor and outputs play data in accordance with a shaking operation of the controller. Alternatively, play data, such as a standard MIDI (musical instrument digital interface) file, may be input into the access module 200A from an apparatus such as a personal computer or via a network.

Each block of the music sound generation system described in the above embodiments may be formed using a single chip with a semiconductor device, such as LSI (large-scale integration), or some or all of the blocks of the music sound generation system may be formed using a single chip.

Although LSI is used as the semiconductor device technology, the technology may be IC (integrated circuit), system LSI, super LSI, or ultra LSI depending on the degree of integration of the circuit. The circuit integration technology employed should not be limited to LSI, but the circuit integration may be achieved using a dedicated circuit or a general-purpose processor. A field programmable gate array (FPGA), which is an LSI circuit programmable after manufactured, or a reconfigurable processor, which is an LSI circuit in which internal circuit cells are reconfigurable or more specifically the internal circuit cells can be reconnected or reset, may be used.

Further, if any circuit integration technology that can replace LSI emerges as an advancement of the semiconductor technology or as a derivative of the semiconductor technology, the technology may be used to integrate the functional blocks. Biotechnology is potentially applicable.

The processes described in the above embodiments may be implemented using either hardware or software (including an additional use of an operating system (OS), middleware, or a predetermined library), or may be implemented using both software and hardware. When the music sound generation system of each of the above embodiments is implemented by hardware, the music sound generation system requires timing adjustment for its processes. For ease of explanation, timing adjustment associated with various signals required in an actual hardware design is not described in detail in the above embodiments.

The sequence in which the processing described in the above embodiments is performed should not be limited to the processing sequence shown in the above embodiments, and the sequence in which the processing is performed may be changed without departing from the scope and spirit of the invention.

Although the above embodiments describe the case in which the access module and the storage module are separate apparatuses, the present invention should not be limited to this structure. The access module and the storage module may be incorporated in a single apparatus. Also, the access module may be an access apparatus, and the storage module may be a storage apparatus.

### INDUSTRIAL APPLICABILITY

The nonvolatile storage system and the music sound generation system of the present invention propose a method for using a nonvolatile memory as a memory for storing music sound data, and are useful as an electronic instrument, a karaoke apparatus, a personal computer having the music sound generating function (for example, a sound card), or a mobile telephone.

1. A nonvolatile storage system including a nonvolatile storage module and an access module that reads data stored in the nonvolatile storage module, wherein
the nonvolatile storage module includes N storage modules consisting of a first storage module to an N-th storage module, where N is a natural number, and data that is stored into the nonvolatile storage module is stored into at least one storage module selected from the first to N-th storage modules, and
the access module includes a data classification unit that determines a storage module storing the data among the N storage modules consisting of the first storage module to the N-th storage module in accordance with a data read command provided from an external unit, and a read command unit that reads data from one of the first to N-th storage modules based on the determination performed by the data classification unit.

2. A music sound generation system, comprising:
a storage module group that includes N storage modules consisting of a first storage module to an N-th storage module, where N is a natural number, and divides music sound data into N pitch groups consisting of a first pitch group to an N-th pitch group, where N is a natural number, and stores the music sound data as being divided in the pitch groups in a manner that music sound data belonging to a k-th pitch group is stored into a k-th storage module, where k is a natural number satisfying 1≦k≦N; and
an access module that transmits a read command for reading data to the storage module group,
wherein the access module includes a sound generation command classification unit that classifies a sound generation command provided from an external unit into N sound generation groups consisting of a first sound generation command group to an N-th sound generation command group, where N is a natural number, and determines a pitch group to which the sound generation command belongs among the N pitch groups, and when determining that the sound generation command belongs to a k-th pitch group, where k is a natural number satisfying 1≦k≦N, the sound generation command classification unit classifies the sound generation command into a k-th sound generation command group, where k is a natural number satisfying 1≦k≦N, and
N read command units that output a data read command to the N storage modules each of which stores music sound data corresponding to a different one of the N sound generation command groups.

3. The music sound generation system according to claim 2, wherein each of the storage modules includes a plurality of nonvolatile storage modules, and the plurality of nonvolatile storage modules store music sound data in a multiplex manner.

4. The music sound generation system according to claim 3, wherein each of the N read command units reads data from a first nonvolatile storage module among the nonvolatile storage modules in accordance with a single sound generation command provided from an external unit, and when receiving another sound generation command before completely reading the data from the first nonvolatile storage module, each of the N read command units reads data in parallel from a second nonvolatile storage module different from the first nonvolatile storage module from which the data is being read among the nonvolatile storage modules.

5. The music sound generation system according to claim 2, wherein each of the N read command units reads a plurality of samples of music sound data in response to a single read command.

6. The music sound generation system according to claim 3, wherein each of the N read command units reads a plurality of samples of music sound data in response to a single read command.

7. The music sound generation system according to claim 4, wherein each of the N read command units reads a plurality of samples of music sound data in response to a single read command.
